(19) United States
(12) Patent Application Publication
(10) Pub. No.: US 2026/0237562 A1
(43) Pub. Date: Aug. 13, 2026

(54) DIELECTRIC CERAMIC COMPOSITION AND LAMINATED CERAMIC ELECTRONIC COMPONENT

(71) Applicant: TAIYO YUDEN CO., LTD., Tokyo (JP)

(72) Inventors: Keiichi HATANO, Tokyo (JP); Yuji TSUSHIMA, Tokyo (JP); Yasuhiro MATSUMOTO, Tokyo (JP)

(73) Assignee: TAIYO YUDEN CO., LTD., Tokyo (JP)

(21) Appl. No.: 19/155,215

(22) PCT Filed: Feb. 8, 2024
(86) PCT No.: PCT/JP2024/004289

§ 371 Date: Aug. 8, 2025

(30) Foreign Application Priority Data
Feb. 14, 2023 (JP) 2023-020850
Jan. 30, 2024 (JP) 2024-011638

(51) Int. Cl. H01G 4/12; C04B 35/468; H01G 4/232; H01G 4/30

(52) U.S. Cl. CPC H01G 4/1272; C04B 35/4682; H01G 4/1227; H01G 4/232; H01G 4/30; C04B 2235/3236; C04B 2235/786; C04B 2235/79

(57) ABSTRACT

A dielectric ceramic composition includes first crystal grains having a perovskite structure represented by a general formula ABO₃, each first crystal grain having a core portion and a shell portion, the shell portion covering the core portion and containing a rare earth element and manganese; and second crystal grains whose main component is a barium titanate complex oxide in which an elemental ratio of barium to titanium is 0.70 or less.

### TECHNICAL FIELD

The present invention relates to a dielectric ceramic composition and a multilayer ceramic electronic component.

### BACKGROUND ART

Multilayer ceramic electronic components such as multilayer ceramic capacitors (MLCC: Multi-Layer ceramic capacitor) are used in high frequency communication systems such as mobile phones.

### RELATED ART DOCUMENT

### Patent Document

Patent Document 1: Japanese Patent Application Laid-Open Publication No. 2012-131669
Patent Document 2: Japanese Patent Application Laid-Open Publication No. 2016-153359

### SUMMARY OF THE INVENTION

### Problems to be Solved by the Invention

In recent years, the use of multilayer ceramic electronic components has been expanding, even in electronic circuits affecting human life, such as in-vehicle electronic control devices. Because of this, high reliability is required and higher mass productivity is also required from the perspective of supply volume.

As the dielectric ceramic composition used for the dielectric layer of multilayer ceramic electronic components, a sintered body with a core-shell structure in which barium titanate is used as a core part and a shell part containing various additives as a solid solution surrounds the core part has been used. By adopting this structure, due to the effects of the various additives, it is possible to shift exhibition of a large capacitance in the shell part that would occur near the Curie temperature where barium titanate changes from the ferroelectric phase to the paraelectric phase, which exists around 125° C., to a lower temperature range, thereby making it possible to produce designs that have increased capacitances in the practical temperature range near room temperature.

It is believed that the core-shell structure is produced by dissolving various additives in barium titanate. It is believed that the core-shell structure is produced by the reaction of various additives added to barium titanate particles, the main component, in the firing temperature range of, for example, 1000° C. to 1400° C. Generally, as the firing temperature increases, various additives dissolve into solid solution and the shell part becomes thicker. Therefore, in order to keep the capacitance of the multilayer ceramic electronic component within the desired range, it is necessary to precisely control the firing temperature.

As an application example of barium titanate without a core-shell structure, a piezoelectric ceramic that contains, as a barium titanate complex oxide, at least one of Ba₄Ti₁₂O₂₇ or Ba₆Ti₁₇O₄₀ and that contains 0.04% to 0.20% by mass or less of manganese with respect to barium titanate has been disclosed (see, for example, Patent Document 1).

Further, a piezoelectric ceramic that contains a metal oxide represented by (Ba₁₋ₓCaₓ)ₐ (Ti_{1-y}Zr_{y})O₃ (where 0.09≤x≤0.30, 0.025≤y≤0.085, 0.986≤a≤1.020) and 0.04 parts by weight or more and 0.36 parts by weight or less of manganese based on 100 parts by weight of the metal oxide, and that contains, as a barium titanate complex oxide, at least one metal oxide selected from BaTi₂O₅, BaTi₄O₉, BaTi₅O₁₁, BaTi₆O₁₃, BaTi₇O₁₄, BaTi₈O₁₆, Ba₂Ti₅O₁₂, Ba₂Ti₆O₁₃, Ba₂Ti₉O₂₀, Ba₄Ti₁₁O₂₆, Ba₄Ti₁₃O₃₀, CaTi₂O₄, CaTi₂O₅, CaTi₄O₉, Ca₂Ti₅O₁₂, CaZr₄O₉, Ca₂Zr₇O₁₆, Ca₆Zr₁₉O₄₄, CaZrTi₂O₇, and Ca₂Zr₅Ti₂O₁₆ has been disclosed (see, for example, Patent Document 2).

When trying to apply the piezoelectric ceramics disclosed in Patent Document 1 and Patent Document 2 to a dielectric ceramic composition used in the dielectric layer of a multilayer ceramic electronic component, it has been realized, as described in Patent Documents 1 and 2, that the maximum grain size of crystal grains becomes 2 μm or more, and it has been found that for multilayer ceramic electronic components where the dielectric layer is 10 μm or less, the number of grain boundaries is reduced and a problem arose in that the insulation properties are significantly deteriorated. Further, the temperature increase rate during firing of the piezoelectric ceramic was at most 10° C./min, and therefore, the high mass productivity required for multilayer ceramic electronic components was not achieved.

In recent years, the applications of dielectric ceramic compositions and multilayer ceramic electronic components have been expanding, and higher mass productivity is required. In order to achieve high mass productivity, firing in a shorter time is required. Therefore, it is necessary to suppress changes in capacitance due to firing temperatures and to reduce fluctuations in capacitance due to temperatures.

The present invention was made in view of the above appreciations of the problems in the art, and an object of the present invention is to provide a dielectric ceramic composition and a multilayer ceramic electronic component that can suppress changes in capacitance due to the firing temperature.

### Means for Solving the Problems

A dielectric ceramic composition according to the present invention includes first crystal grains having a perovskite structure represented by a general formula ABO₃, the first crystal grains each having a core portion and a shell portion covering the core portion and containing a rare earth element and manganese, and second crystal grains whose main component is a barium titanate complex oxide in which an elemental ratio of barium to titanium is 0.70 or less.

In the dielectric ceramic composition above, the rare earth element may be at least one selected from gadolinium, europium, terbium, dysprosium, holmium, erbium, and ytterbium.

In the dielectric ceramic composition above, the elemental ratio of barium to titanium may be 0.926 or more and 0.995 or less, an elemental ratio of the rare earth element to titanium may be 0.005 or more and 0.05 or less, and an elemental ratio of manganese to titanium may be 0.002 or more and 0.05 or less.

The dielectric ceramic composition above may further contain silicon having an elemental ratio of 0.002 or more and 0.05 or less with respect to titanium and magnesium having an elemental ratio of 0.00 or more to 0.05 or less with respect to titanium.

In the dielectric ceramic composition above, element concentrations of the rare earth element and manganese in the shell portion may be higher than element concentrations of the rare earth element and manganese in the core portion.

In the dielectric ceramic composition above, the first crystal grains may have a maximum grain size of 2 μm or less.

In the dielectric ceramic composition above, the second crystal grain may have an elemental ratio of barium to titanium of 0.16 or more.

In the dielectric ceramic composition above, the second crystal grain may be at least one selected from BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

In the dielectric ceramic composition above, the second crystal grain may contain manganese, and an elemental ratio of manganese to titanium in the second crystal grain may be 0.02 or more and 0.10 or less.

In the dielectric ceramic composition above, the second crystal grain may contain manganese, and an elemental ratio of manganese to titanium in the second crystal grain may be 0.02 or more and 0.05 or less.

Another dielectric ceramic composition according to the present invention includes first crystal grains having a perovskite structure represented by a general formula ABO₃, the first crystal grains each having a core portion and a shell portion covering the core portion and containing a rare earth element and manganese; and second crystal grains which is a barium titanate complex oxide represented by Ba₄Ti₁₁O₂₆, and containing manganese with an elemental ratio of manganese to titanium being 0.02 or more and 0.10 or less.

In the dielectric ceramic composition above, the rare earth element may be at least one selected from gadolinium, europium, terbium, dysprosium, holmium, erbium, and ytterbium.

In the dielectric ceramic composition above, the elemental ratio of barium to titanium may be 0.926 or more and 0.995 or less, an elemental ratio of the rare earth element to titanium may be 0.005 or more and 0.05 or less, and an elemental ratio of manganese to titanium may be 0.002 or more and 0.05 or less.

The dielectric ceramic composition above may further contain silicon having an elemental ratio of 0.002 or more and 0.05 or less with respect to titanium and magnesium having an elemental ratio of 0.00 or more and 0.05 or less with respect to titanium.

In the dielectric ceramic composition above, element concentrations of the rare earth element and manganese in the shell portion may be higher than element concentrations of the rare earth element and manganese in the core portion.

In the dielectric ceramic composition above, the first crystal grains may have a maximum grain size of 2 μm or less.

In the dielectric ceramic composition above, the elemental ratio of manganese to titanium in the second crystal grains may be 0.02 or more and 0.05 or less.

A multilayer ceramic electronic component according to the present invention uses any one of the dielectric ceramic compositions as set forth above.

The above-described multilayer ceramic electronic component includes a plurality of internal electrodes facing each other; dielectric layers provided between the plurality of internal electrodes and containing the dielectric ceramic composition according to claim 1; and external electrodes electrically connected to the internal electrodes, respectively.

### Effects of the Invention

According to the present invention, it is possible to provide a dielectric ceramic composition and a multilayer ceramic electronic component that can suppress changes in capacitance due to firing temperature.

### BRIEF DESCRIPTION OF THE DRAWINGS

FIG. 1 is a diagram illustrating a dielectric ceramic composition according to a first embodiment.

FIG. 2 is a diagram illustrating a unit cell.

FIG. 3 is a diagram illustrating a method for confirming a core-shell structure.

FIG. 4 is a partial cross-sectional perspective view of a multilayer ceramic capacitor.

FIG. 5 is a sectional view taken along the line A-A in FIG. 4.

FIG. 6 is a sectional view taken along the line B-B in FIG. 4.

FIG. 7 is a diagram illustrating a flow of a method for manufacturing a multilayer ceramic capacitor.

FIG. 8(a) and FIG. 8(b) are diagrams illustrating an internal electrode forming process.

FIG. 9 is a figure which illustrates a crimping process.

FIG. 10 is a figure which illustrates side margin parts.

### DETAILED DESCRIPTION OF EMBODIMENTS

Hereinafter, embodiments will be described with reference to the drawings.

### First Embodiment

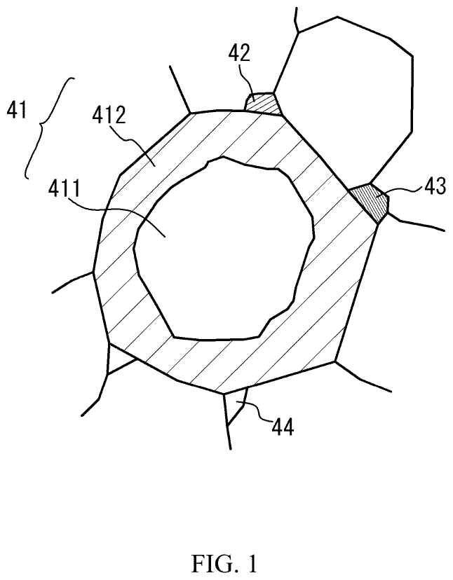

The dielectric ceramic composition according to a first embodiment is a ceramic polycrystalline body containing crystal grains having a perovskite structure represented by the general formula ABO₃, as illustrated in FIG. 1. Among the ceramic polycrystalline body, at least one thereof is a first crystal grain 41 having a core-shell structure, and at least another thereof is a second crystal grain 42 in which the elemental ratio of barium to titanium is 0.70 or less.

The first crystal grain 41 includes a substantially spherical core portion 411 and a shell portion 412 that surrounds and covers the core portion 411. The core portion 411 is a crystalline portion in which the additive compound is not dissolved in solid solution or the amount of the additive compound in solid solution is small. The shell portion 412 is a crystalline portion in which the additive compound is dissolved in solid solution and has a higher concentration of the additive compound than the concentration of the additive compound in the core portion 411. In this embodiment, the shell portion 412 contains rare earth elements and manganese. The rare earth element is not particularly limited, but may be at least one selected from gadolinium, europium, terbium, dysprosium, holmium, erbium, and ytterbium. Further, the element concentrations of rare earth elements and manganese in the shell portion 412 are higher than those in the core portion 411.

By including the first crystal grains 41 and the second crystal grains 42, the dielectric ceramic composition according to the present embodiment can suppress changes in capacitance due to firing temperature.

For example, when observing a cross section of the dielectric ceramic composition in a field of view where 400 or more first crystal grains 41 and second crystal grains 42 are observed in total, the area ratio of the first crystal grains 41 is 50% or more and 99.95% or less, and the area ratio of the second crystal grains 42 is 0.05% or more and 50% or less.

Note that, in addition to the first crystal grains 41 and the second crystal grains 42, the dielectric ceramic composition may also include third crystal grains 43 having a different composition or crystal structure from these, and voids 44 and the like. For example, when observing a cross section of the dielectric ceramic composition in a field of view in which a total of 400 or more first crystal grains 41, second crystal grains 42, and third crystal grains 43 are observed, the area ratio of the third crystal grains 43 is 0.05% or more and 20% or less.

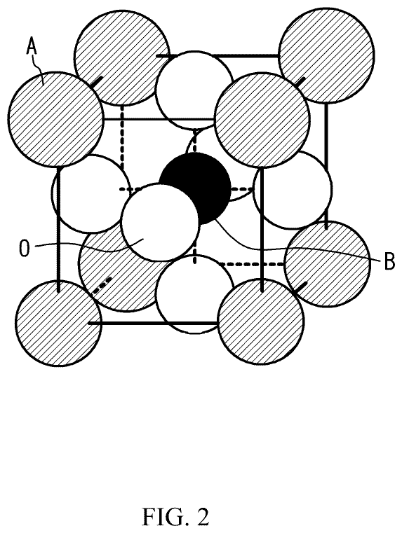

Crystal grains having a perovskite structure, which are the main components of the first crystal grains 41, have a unit cell as illustrated in FIG. 2. This unit cell has the A site located at the apex of the lattice, the O site located at the face center of the lattice, and the B site located within an octahedron with the O site as the apex. In the perovskite structure, alkaline earth metals that can take divalent cations such as barium (Ba), strontium (Sr), and calcium (Ca) are located at the A site, and hafnium (Hf) and zirconium (Zr) are located at the B site, titanium (Ti), and other metal atoms that can form tetravalent cations.

The perovskite structure also allows a composition formula that deviates from the stoichiometric composition. That is, the ratio of the A-site element to the B-site element does not necessarily have to be 1:1, and defects may be generated within a range where the perovskite structure can be maintained. Furthermore, defects may also be generated regarding oxygen. For example, when the composition formula is A_{α}BO_{3-β}, compositions in the ranges of 0.98≤α≤1.01 and 0≤β≤0.20 are allowed.

However, due to the generation of oxygen defects, for example, the resistivity decreases and ionic conductivity is exhibited, which reduces the electrical life when used as a multilayer ceramic capacitor and increases the dielectric loss, which in turns make it not practical for use. Therefore, if necessary, at least one of the first transition elements: scandium (Sc), titanium (Ti), vanadium (V), chromium (Cr), iron (Fe), cobalt (Co), nickel (Ni), copper (Cu), zinc (Zn) may be added to the first crystal grains 41 having a perovskite structure. This makes it possible to improve resistivity, extend electrical life, and reduce dielectric loss of capacitance.

In addition, the first crystal grains (which may be referred to as particles) 41 may include at least one of the second transition elements such as yttrium (Y), zirconium (Zr), niobium (Nb), molybdenum (Mo), ruthenium (Ru), rhodium (Rh), palladium (Pd) and silver (Ag). This makes it possible to improve resistivity, extend electrical life, and reduce dielectric loss of capacitance.

In addition, the first crystal grains 41 may include at least one of the third transition elements such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), and gold (Au). This makes it possible to improve resistivity, extend electrical life, and reduce dielectric loss of capacitance.

For example, to the dielectric ceramic composition, it is preferable to add titanium in an amount of 0.5 mol or more and 8.0 mol or less in terms of titanium oxide (TiO₂) for 100 mol of barium titanate so that the Ba/Ti element ratio x, which is the element ratio of barium to the titanium content, satisfies 0.926≤x≤0.995. In this case, the solid solution reaction to the barium titanate crystal particles is relatively suppressed compared to the case where no additive containing titanium is added. Because of this, when applied to multilayer ceramic capacitors, which require high mass production, it becomes possible to achieve firing in a shorter time while suppressing the rate of change in capacitance due to changes in firing temperature, thereby achieving high mass productivity.

To the dielectric ceramic composition, it is more preferable to add titanium in an amount of 2.0 mol or more and 6.4 mol or less in terms of titanium oxide (TiO₂) for 100 mol of barium titanate so that the Ba/Ti element ratio x satisfies 0.940≤x≤0.980. With this, a sufficient amount of second crystal grains 42 can be generated in the dielectric ceramic composition, and it becomes possible to better suppress the range of change in capacitance due to change in firing temperature.

Preferred examples of the above titanium-containing additives include titanium oxide, titanium hydroxide (Ti(OH)₄), titanium chloride (TiCl₄), titanium carbide (TiC), and titanium sulfide (TiS₂), etc., can also be used.

Furthermore, to the dielectric ceramic composition, it is preferable to add gadolinium in an amount of 0.25 mol or more and 2.5 mol or less in terms of gadolinium oxide (Gd₂O₃) for 100 mol of barium titanate such that the Gd/Ti element ratio y, which is the element ratio of the rare earth element, for example, gadolinium to the titanium content, is 0.005≤y≤0.05.

In addition to adding gadolinium oxide, it is preferable to add manganese in the amount of 0.2 mol or more and 5.0 mol or less in terms of manganese oxide (MnO) for 100 mol of barium titanate so that the Mn/Ti element ratio z, which is the manganese element ratio to the titanium content, satisfies 0.002≤z≤0.05.

For example, when 0.926≤x≤0.995, 0.005≤y≤0.05, and 0.002≤z≤0.05, the added gadolinium, manganese, and titanium react on the surface of barium titanate crystal grains, and form a shell part in the form of a composite perovskite compound considered to be Gd(Ti, Mn)O₃. As a result, the resultant dielectric ceramic composition not only suppresses the range of change in capacitance caused by changes in firing temperature, but also suppresses the movement of oxygen defects within the grain boundaries and shell parts, thereby suppressing a decrease in resistivity and improving the electrical life.

Even more preferably, it is desirable to adjust the amount of gadolinium and the amount of manganese so that 0.005≤y≤0.02 and 0.005≤z≤0.02 are satisfied. At this time, in the dielectric ceramic composition, excessive solid solution of excess gadolinium into crystal grains made of barium titanate and precipitation of excess manganese on the surface of the dielectric ceramic composition are suppressed. This makes it possible to further suppress the range of change in capacitance due to changes in firing temperature, and to maintain high resistivity.

In addition to additives containing gadolinium, manganese, and titanium, silicon may be added in an amount of 0.2 mol or more and 5.0 mol or less in terms of silicon (SiO₂) so that the Si/Ti element ratio a, which is the elemental ratio of silicon to the titanium content, satisfies 0.002≤a≤0.05. Further, magnesium may be added in an amount of 0 mol or more and 5.0 mol or less in terms of magnesium oxide (MgO) so that the Mg/Ti element ratio b, which is the elemental ratio of magnesium to the titanium content, satisfies 0.00≤b≤0.05. With these additives, the dielectric ceramic composition generates first crystal grains 41 containing silicon and/or second crystal grains 42 that become glass grains, and generates a liquid phase inside during firing so as to produce denser ceramic at a lower temperature. In addition, by adding magnesium oxide, it is possible to form a shell part in the form of Gd(Mg, Ti, Mn)O₃ or (Gd, Ba)(Mg, Ti, Mn)O₃, thereby further suppressing oxygen defects from moving within the grain boundaries and the shell portion, thereby suppressing a decrease in resistivity.

Even more preferably, it is desirable that 0.005≤a≤0.02, and it is desirable that 0.002≤b≤0.02. With these conditions, it is possible to suppress excessive additives from being generated as third crystal grains 43, and suppression of a decrease in relative dielectric constant, the effect of densification at low temperature and suppression of a decrease in resistivity can be achieved.

Now, among the first transition metal elements, second transition metal elements, and third transition metal elements, the rare earth elements are cerium, praseodymium, neodymium, samarium, europium, gadolinium, terbium, dysprosium, holmium, erbium, thulium, ytterbium, and lutetium. By using those rare earth elements as an additive, the rare earth element is solid-dissolved from the interface to the inside of the first crystal grains 41 in the firing temperature range of 1000° C. to 1400° C. for forming the dielectric ceramic composition, and it becomes possible to obtain crystal grains having a core-shell structure with a shell portion and a core portion.

Generally, in a core-shell structure, as the firing temperature increases, more of various additives are solid-dissolved in the crystal grains made of barium titanate, and the shell portion tends to become thicker. In the shell portion, a large capacitance region, which would occur near 125° C. near the Curie temperature of barium titanate, is exhibited at a temperature approaching room temperature. As a result, the capacitance in the practical temperature range near room temperature changes greatly depending on the thickness of the shell portion. Therefore, for example, in order to keep the capacitance of a multilayer ceramic capacitor within a desired range, it is necessary to precisely control the firing temperature.

The dielectric ceramic composition according to the present embodiment is produced by firing at a temperature of 1,000° C. to 1,300° C., and by rapidly raising the temperature during the firing process at a rate from 3,000° C./h to 10,000° C./h.

The first crystal grain 41 having a core-shell structure in which a shell portion 412 containing a rare earth element and manganese is formed has a production process different from that of a conventional core-shell structure. Specifically, in addition to solid solution of the rare earth element in the barium titanate crystal particles, the added rare earth element, manganese, and titanium react on the surface of the barium titanate crystal particles to form a shell portion in the form of a complex perovskite compound such as Gd(Ti, Mn)O₃.

Furthermore, added magnesium may react on the surface of the barium titanate crystal grains, so as to form the shell portion 412 in the form of a complex perovskite compound such as Gd(Mg, Ti, Mn)O₃.

The shell portion 412 in the form of a complex perovskite compound considered to be Gd(Ti, Mn)O₃ or Gd(Mg, Ti, Mn)O₃ may be configured to react with barium titanate crystal particles which are the main component of the surrounding to form a shell portion made of (Gd, Ba)(Ti, Mn)O₃ or (Gd, Ba)(Mg, Ti, Mn)O₃.

For example, the core portion 411 in the core-shell structure is mainly composed of crystal grains made of barium titanate, but may also contain added rare earth elements, manganese, magnesium, etc. However, for example, it is sufficient that the shell portion 412 contains relatively more rare earth elements, manganese, magnesium, etc. among the additives than the core portion 411.

More specifically, the crystal grains of the present embodiment has a core-shell structure, in which the main components are crystal grains consisting of barium titanate, and a shell containing gadolinium and manganese, and includes gadolinium and manganese in terms of the elemental ratios to titanium in relatively higher amounts in any point in 10% of the diameter of the crystal grains from the grain surface, as compared with the elemental ratios at the center of the grain. Due to the presence of crystal grains with such a core-shell structure, the polycrystalline body constituting the dielectric ceramic composition not only suppresses the range of change in capacitance that it retains due to changes in firing temperature, but also suppresses oxygen defects from moving in the grain boundaries and inside the shell portion, thereby suppressing a decrease in resistivity, and improving the electrical life.

Here, the average grain diameter of the first crystal grains 41 in the dielectric ceramic composition is within the range of 50 nm to 500 nm, and giant grains of 3 μm or more are not retained in the portion that is electrically utilized as a dielectric. For example, in the dielectric ceramic composition, the maximum grain size of the first crystal grains is preferably 2 μm or less. In view of the general characteristic of ceramics that the particle diameter and composition distribution of the crystal grains therein fall within a relatively narrow range, if it can be confirmed that some of the first crystal grains 41 have a core-shell structure, it can be said that a large number of first crystal grains 41 having a similar structure exist and produce positive effects on the electrical life of the dielectric ceramic composition.

The particle diameter of the first crystal grains 41 can be measured by the following procedure. The dielectric ceramic composition having the first crystal grains 41 is cut or polished to expose an observation surface. This exposure method is not particularly limited, and any method of cutting or polishing the device can be adopted. At this time, in order to fully observe the internal ceramic structure, it is preferable to obtain a smoothness that can be considered as a mirror surface using a diamond paste of 2 μm or less or the like. Next, after depositing a conductive substance such as platinum or osmium on the observation surface, observation is performed using a scanning electron microscope (SEM), and a photograph of the first crystal grains 41 is taken. Next, a plurality of mutually parallel straight lines is drawn in the taken photograph, and the length of the line segment cut by cutting each straight line at the periphery of each first crystal particle 41 (the distance between two intersecting points at which each straight line crosses the periphery of the first crystal particle 41) is measured as the grain diameter (grain size) of the first crystal grains 41. Using this method, the grain size of the first crystal grains 41 is measured for 400 or more grains, and the average of the obtained results is taken as the average grain size of the first crystal grain 41. In addition, if the outline of the first crystal grains 41 is difficult to see in the exposed ceramic, the exposed ceramic may be heated for about 5 minutes at a temperature about 50° C. lower than that at which it was fired prior to vapor deposition of platinum, osmium, etc. Instead of this heat treatment, it is possible to use chemical etch using hydrofluoric acid, hydrochloric acid, sulfuric acid, nitric acid, or a mixture thereof at an appropriate concentration for etching.

The core-shell structure of the first crystal grain 41 is formed by adding gadolinium, manganese, and titanium that are reacting on the surface of barium titanate crystal grain to form, as a shell portion, a complex perovskite compound that is considered to be Gd(Ti, Mn)O₃, Gd(Mg, Ti, Mn)O₃, (Gd, Ba)(Ti, Mn)O₃, or (Gd, Ba)(Mg, Ti, Mn)O₃. Here, since the added titanium is involved in the reaction, the solid solution reaction to the barium titanate crystal grains is relatively suppressed compared to the case where titanium is not added. Because of this, when this material is used for multilayer ceramic capacitors, which require high mass production, for example, it is possible to achieve firing in a shorter time while suppressing the range of change in capacitance due to changes in firing temperature, thereby achieving high mass productivity.

Here, the presence of the first crystal grains 41 having a core-shell structure in the dielectric ceramic composition can be confirmed by the following procedure.

First, a sample for transmission electron microscopy (TEM) observation is cut out from the dielectric ceramic composition to be evaluated. This cutting out can be performed using a focused ion beam (FIB) device or the like.

Next, the cut sample for TEM observation is observed with a TEM equipped with an energy dispersive X-ray spectrometer (EDS) or a wavelength dispersive X-ray spectrometer (WDS) to determine the crystal grains to be measured, and at the same time, determine the outer circumferential shape of the grains.

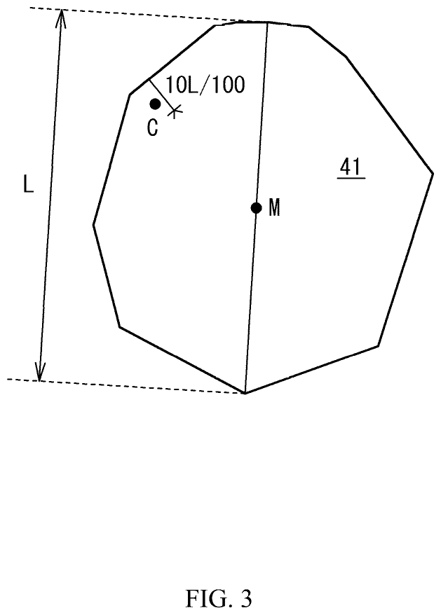

Next, as illustrated in FIG. 3, among the line segments connecting arbitrary two points located on the outer periphery of the crystal grain to be measured, the one with the maximum length is determined, and the length L of the line segment is measured. Then, this length L is taken as the diameter of the crystal grain to be measured. Furthermore, the midpoint M of the line segment is determined from the obtained length of the line segment.

Then, a composition analysis is performed using EDS or WDS on an arbitrary point C on the outer periphery within a length range of 10% of the diameter of the crystal grain, that is, 10 L/100, from both ends of the above line segment so as to obtain the element abundance ratio of the target element relative to the titanium element. The compositional analysis, for example, EDS measurement, may be performed by evaluating the K-line intensity of titanium relative to the K-line or L-line intensity of barium, the L-line intensity of gadolinium, the K-line intensity of manganese. More specifically, from these intensities, a correction (ZAF correction) is performed that takes into account the atomic number effect, absorption effect, and fluorescence excitation effect, and the ratio of each of the elemental content relative to titanium is calculated for the shell portion 412. Furthermore, the compositional analysis is similarly performed for the midpoint M of the above line segment to calculate the ratios of the respective element relative to titanium in the core portion 411.

Then, the ratio of each element to titanium in the shell part 412 and the ratio of each element to titanium in the core part 411 were compared, and if the ratios in the shell part 412 was higher than the core part 411, it is determined that the crystal particles 41 have a core-shell structure.

In addition to the first crystal grains 41, the dielectric ceramic composition includes, as second crystal grains 42 other than the first crystal grains 41, at least one second crystal particle 42 made of a barium titanate complex oxide in which the elemental ratio of barium to titanium is 0.70 or less.

In the second crystal grains 42, the element ratio of barium to titanium is preferably 0.16 or more. Further, the second crystal grains 42 may contain manganese. The element ratio of manganese to titanium in the second crystal grains may be 0.02 or more and 0.10 or less, or 0.02 or more and 0.05 or less.

Examples of the second crystal grains 42 include BaTi₂O₅, BaTi₄O₉, BaTi₅O₁₁, BaTi₆O₁₃, Ba₄Ti₁₁O₂₆, Ba₄Ti₂O₂₇, Ba₄Ti₁₃O₃₀, Ba₆Ti₁₇O₄₀, and the like.

As is clear from its compositional formula, the second crystal grains 42 are barium titanate complex oxide with a smaller amount of barium than barium titanate. As described above, in the dielectric ceramic composition according to the present embodiment, because the shell portion 412 is formed of a complex perovskite compound considered to be the form of Gd(Ti, Mn)O₃, Gd(Mg, Ti, Mn)O₃, or (Gd, Ba)(Ti, Mn)O₃, the second crystal grains 42 are produced as a by-product when an additive having titanium as the main component is used. By intentionally precipitating the second crystal grains 42 in forming the first crystal grains 41, in a multilayer ceramic capacitor, for example, for which high mass productivity is required, the range of change in capacitance due to a change in firing temperature can be suppressed and high mass productivity can be achieved. Further, in the dielectric ceramic composition according to the present embodiment including the second crystal grains 42, firing at a relatively high temperature is required in order to form the shell portion 412 in the form of the complex perovskite compound described above. If firing is performed at a temperature increase rate of at most 10° C./min (600° C./h) as disclosed in Patent Document 1 and Patent Document 2, it was confirmed that the second crystal grains 42 grow large and exceed 10 μm, creating huge grains. In order to eliminate this, it is preferable that the dielectric ceramic composition according to the present embodiment is rapidly heated at the rate of 3,000° C./h to 10,000° C./h so as to minimize the thermal energy added to the firing process, thereby performing the firing process while suppressing grain growth.

A preferable example of the second crystal grains 42 is a barium titanate complex oxide represented by Ba₄Ti₁₁O₂₆, which is monoclinic and has a space group C2/m, and has lattice constants a=15.160 Å, b=3.893 Å, and c=9.093 Å with β=98.6°. This is because this barium titanate complex oxide has a ratio of barium to titanium that is relatively close to 1, and can be easily precipitated intentionally without using a large amount of additives having its main component as titanium. This barium titanate complex oxide is described, for example, in the non-patent literature Acta Cryst. (1979). B35, 1590-1593.

As a more preferable example of the second crystal grains 42, it is desirable that manganese is solid-dissolved in Ba₄Ti₁₁O₂₆ to occupy the defect sites thereof, or replace some titanium. As is clear from the above-mentioned non-patent literature, Ba₄Ti₁₁O₂₆ has a crystal structure in which some titanium sites have defects. Therefore, titanium tends to change from a tetravalent cation to a trivalent cation at the defect location, and as a result, the resistivity tends to decrease. In order to supplement this, it is effective to include manganese in solid solution.

Here, whether or not the dielectric ceramic composition contains the second crystal grains 42 can be determined by the following procedure.

First, the diffraction line profile of the surface of the dielectric ceramic composition to be evaluated or the powder obtained by crushing the dielectric ceramic composition to be evaluated is measured using an X-ray diffractometer (XRD) using Cu-Kα rays. The pulverizing method for obtaining the powder is not particularly limited, and a hand mill (mortar/pestle) or the like can be used. In addition, when measuring the diffraction profile of the ceramics that make up a multilayer ceramic capacitor, it is necessary to remove the electrodes and coatings formed on the surface of the device, as well as parts other than the dielectric layers of the multilayer ceramic capacitor, thereby exposing the surface of the dielectric ceramic composition. This exposure method is not particularly limited, and any method of cutting or polishing the device can be adopted. In addition, when measuring the diffraction profile of the powder of the dielectric ceramic composition that makes up the multilayer ceramic capacitor, the electrodes and coatings formed on the device, as well as parts other than the dielectric layer of the multilayer ceramic capacitor, are preferably removed before crushing it.

Next, in the obtained diffraction profile, the percentage of the strongest diffraction line intensity derived from other structures with respect to the strongest diffraction line intensity derived from the perovskite structure is calculated. If this ratio is 10% or less, it is determined that the dielectric ceramic composition to be evaluated is composed of first crystal grains 41 having a perovskite structure. In addition, when the surface of the dielectric ceramic composition of a multilayer ceramic capacitor is exposed using the above method, or when XRD measurement is performed on pulverized powder, peaks of the materials constituting the electrodes and coatings may also be detected. Therefore, the above-mentioned ratio of diffraction line intensity is calculated after excluding these.

Next, the crystal phase is evaluated by focusing on peaks other than the diffraction line intensities derived from the perovskite structure. In doing so, it is preferable to refer to the PDF (Powder Diffraction File) published by ICDD (International Centre for Diffraction Data; Pennsylvania, USA) in order to search and identify the second crystal grains 42. In case of Ba₄Ti₁₁O₂₆ as a preferred example, its production can be evaluated by identifying it with reference to PDF-01-083-1459.

Next, using the following method, whether or not the second crystal particles 42 are made of a barium titanate complex oxide in which the elemental ratio of barium to titanium is 0.70 or less is determined.

First, the surface of the dielectric ceramic composition is exposed. This exposure method is not particularly limited, and any method of cutting or polishing the device can be adopted. At this time, in order to fully observe the internal ceramic structure, it is preferable to obtain a smoothness that can be judged as a mirror surface by using a diamond paste of 2 μm or less or the like.

Next, an energy dispersive X-ray spectrometer (EDS) or a wavelength dispersive X-ray spectrometer (WDS), which is attached to a scanning electron microscope (SEM) or transmission electron microscope (TEM), or an electron probe microanalyzer (EPMA), or a laser irradiation inductively coupled plasma mass spectrometry (LA-ICP-MS) or the like is used to analyze the composition of the second crystal grains 42.

For example, in EDS measurement, simply, the K-line intensity of titanium relative to the K-line or L-line of barium or the K-line of manganese can be used to analyze the composition. More specifically, from these intensities, a correction (ZAF correction) is performed that takes into account the atomic number effect, absorption effect, and fluorescence excitation effect, and the ratio of each to the elemental content of titanium is calculated, and the ratio of each element is calculated.

When performing EDS measurements, especially when using barium's Lα ray and titanium's Kα ray, their energy peaks are close to each other, and it may be difficult to adequately compare the element contents. For this reason, it is desirable that the Lβ2 line and LIIIab line of barium, which do not have peak overlap, be obtained with sufficient intensity for the measurement. Specifically, it is preferable that the intensity at the peak is 10,000 counts or more. This way, the intensity of the characteristic X-rays from barium can be determined and the element content can be calculated, so even if the Lα line of barium and the Kα line of Ti overlap, the intensity of the Kα rays of titanium can be determined, and the element content can be evaluated with high accuracy.

When the elemental ratio of barium to titanium obtained by the above method is 0.70 or less, the evaluated crystal grain is determined to be the second crystal grain 42. That is, it is determined that it is one of the above-mentioned barium titanate complex oxides based on the fact that the elemental ratio of barium to titanium is small compared to the first crystal grain 41 made of barium titanate existing in the surroundings. Here, when an SEM is used for observation, the second crystal grains 42 have a relatively low brightness (i.e., darker image) compared to the first crystal grain 41 in the observation using a back scattered electron image (BSE image). Moreover, as an even more preferable evaluation method, the second crystal grains 42 may be evaluated by using the diffraction profile by XRD.

In more detail, the part determined to be the second crystal grain 42 is cut out as a sample for transmission electron microscopy (TEM) observation, and a diffraction image obtained using a selected area diffraction method is obtained. By comparing with data from literature, it can be confirmed whether it can be determined as one of BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, and Ba₆Ti₁₇O₄₀. Note that this cutout can be performed using an FIB device or the like.

The solid solution of manganese in the second crystal grains 42 can be evaluated by the intensity of the titanium K line relative to the Mn K line by EDS, WDS, or EPMA. More specifically, the ZAF correction is performed on these intensities to calculate the ratio w of the elemental content of manganese to the elemental content of titanium. Here, it is preferable that the range is 0.02≤w≤0.10, more preferably 0.02≤w≤0.05. For example, manganese becomes a solid solution in the defect position of the Ti site in Ba₄Ti₁₁O₂₆, and a decrease in resistivity of the dielectric ceramic composition can be suppressed.

Furthermore, the dielectric ceramic composition may contain third crystal grains 43 having a different composition or crystal structure from the first crystal grains 41 and the second crystal grains 42. Further, the dielectric ceramic composition may contain silicon-containing crystal particles or glass particles. This makes it possible to sufficiently densify the dielectric ceramic composition by firing it at 1300° C. or lower.

The third crystal grains 43 may generally be crystal particles or glass particles such as silicate (SiO₂), enstatite (MgSiO₃), barium magnesium silicate (BaMgSiO₄), or fresnoite (Ba₂TiSi₂O₈).

In addition, examples of the third crystal grains 43 include compounds produced from added substances, such as geikielite (MgTiO₃), manganese nickel oxide ((Mn, Ni)O), and pyrophanite (MnTiO₃), or compounds produced from electrodes.

### Second Embodiment

As a second embodiment, a multilayer ceramic capacitor 100 using the dielectric ceramic composition according to the first embodiment will be described.

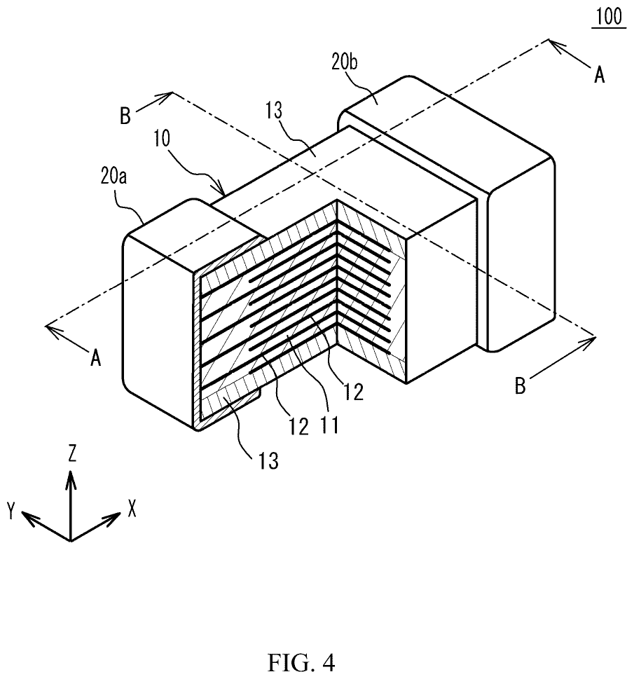

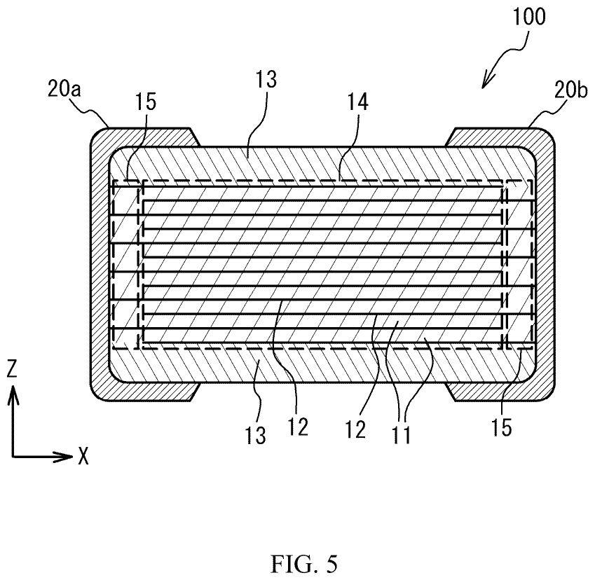

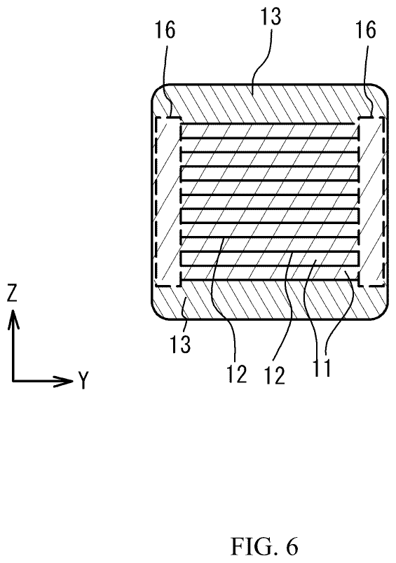

FIG. 4 is a partially cross-sectional perspective view of the multilayer ceramic capacitor 100. FIG. 5 is a cross-sectional view taken along the line A-A in FIG. 4. FIG. 6 is a cross-sectional view taken along the line B-B in FIG. 4. As illustrated in FIGS. 4 to 6, the multilayer ceramic capacitor 100 includes a multilayer chip 10 having a substantially rectangular parallelepiped shape, and external electrodes 20a and 20b provided on two opposing end surfaces of the multilayer chip 10. Note that, of the four surfaces of the multilayer chip 10 other than the two end surfaces, two surfaces other than the upper surface and the lower surface in the stacking direction are referred to as side surfaces. The external electrodes 20a and 20b extend on the top surface, bottom surface, and two side surfaces of the stacked chip 10 in the stacking direction. However, the external electrodes 20a and 20b are spaced apart from each other.

The multilayer chip 10 has a structure in which dielectric layers 11 containing a dielectric ceramic composition and internal electrode layers 12 containing a base metal material are alternately laminated. The edges of each internal electrode layer 12 are exposed alternately on the end surface where the external electrode 20a of the multilayer chip 10 is provided and the end surface where the external electrode 20b is provided. Thereby, the respective internal electrode layers 12 are alternately electrically connected to the external electrodes 20a and 20b. As a result, multilayer ceramic capacitor 100 has a structure in which a plurality of dielectric layers 11 are stacked with internal electrode layers 12 in between. Further, in the laminate of the dielectric layer 11 and the internal electrode layer 12, the internal electrode layer 12 is disposed as the outermost layer in the stacking direction, and the top and bottom surfaces of the laminate are each covered with cover layers 13. The cover layer 13 has a ceramic material as a main component. For example, the cover layer 13 has the same ceramic main component as the dielectric layer 11.

The size of the multilayer ceramic capacitor 100 is, for example, 0.25 mm long, 0.125 mm wide, and 0.125 mm high, or 0.4 mm long, 0.2 mm wide, and 0.2 mm high, or 0.6 mm long, 0.3 mm wide, and 0.3 mm high, or 1.0 mm long, 0.5 mm wide, and 0.5 mm high, or 3.2 mm long, 1.6 mm wide, and 1.6 mm high, or 4.5 mm high, 3.2 mm side, and 2.5 mm high, but the size is not limited to these.

The internal electrode layer 12 has a base metal such as Ni (nickel), Cu (copper), Sn (tin) as a main component. As the internal electrode layer 12, noble metals such as Pt (platinum), Pd (palladium), Ag (silver), and Au (gold), or alloys containing these metals may be used.

As illustrated in FIG. 4, the region where the internal electrode layer 12 connected to the external electrode 20a and the internal electrode layer 12 connected to the external electrode 20b face each other is a region in which capacitance occurs in the multilayer ceramic capacitor 100. Therefore, the region where the electric capacitance occurs is referred to as a capacitance region 14. That is, the capacitance region 14 is a region where adjacent internal electrode layers 12 connected to different external electrodes face each other.

The region where the internal electrode layers 12 connected to the external electrode 20a face each other without interposing the internal electrode layer 12 connected to the external electrode 20b is referred to as an end margin 15. Further, an end margin 15 is also a region where the internal electrode layers 12 connected to the external electrode 20b face each other without interposing the internal electrode layer 12 connected to the external electrode 20a. That is, the end margin 15 is a region where internal electrode layers 12 connected to the same external electrode face each other without interposing the internal electrode layers 12 connected to the other external electrode. The end margin 15 is an area where no capacitance occurs.

As illustrated in FIG. 6, in the multilayer chip 10, the area from the two side surfaces of the multilayer chip 10 reaching the internal electrode layer 12 is referred to as a side margin 16. That is, the side margin 16 is a region provided so as to cover the side ends of the plurality of stacked internal electrode layers 12 extending toward one of the two side surfaces in the stacked structure. The side margin 16 is also a region that does not generate capacitance.

In the multilayer ceramic capacitor 100 according to the present embodiment, at least a portion of the dielectric layer 11 in the capacitance region 14 includes the first crystal grains 41 illustrated in FIG. 2 and also includes the second crystal grains 42. Thereby, the rate of change in capacitance due to changes in firing temperature can be suppressed and high mass productivity can be achieved.

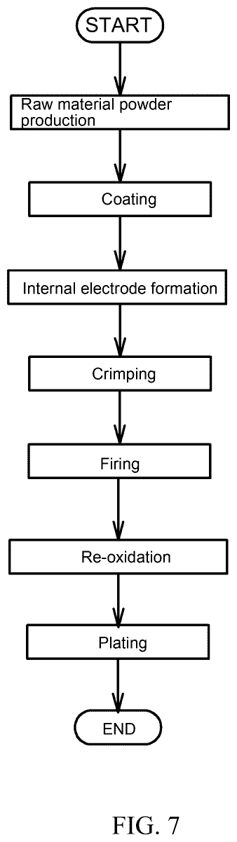

Next, a method for manufacturing the multilayer ceramic capacitor 100 will be described. FIG. 7 is a diagram illustrating a flow of a method for manufacturing the multilayer ceramic capacitor 100.

### (Raw Material Powder Production Process)

First, a dielectric ceramic composition for forming the dielectric layers 11 is prepared. The A-site element and the B-site element contained in the dielectric layer 11 are usually contained in the dielectric layer 11 in the form of a sintered body of ABO₃ particles. For example, barium titanate is a compound that has a perovskite structure and belongs to the tetragonal system near room temperature, and exhibits a high dielectric constant. This barium titanate can generally be synthesized by reacting a titanium raw material such as titanium dioxide with a barium raw material such as barium carbonate. Various methods are conventionally known for synthesizing barium titanate, which is the main component of the dielectric layer 11, such as a solid phase method, a sol-gel method, and a hydrothermal method. In this embodiment, any of these can be adopted.

Prescribed additives are added to the barium titanate powder obtained by the above method. As an example, additives within the range explained above in the example of the dielectric ceramic composition according to the first embodiment are used. If necessary, an oxide or glass containing Zr (zirconium), V (vanadium), Cr (chromium), Co (cobalt), Ni (nickel), Li (lithium), B (boron), Na (sodium), or K (potassium), may also be used. Also if necessary, an oxide of Sc (scandium), Y (yttrium), La (lanthanum), Ce (cerium), Pr (praseodymium), Nd (neodymium), Pm (promethium), Sm (samarium), Eu (Europium), Tb (terbium), Dy (dysprosium), Ho (holmium), Er (erbium), Tm (thulium), Y (ytterbium), or Lu (lutetium), as rare earth elements other than Gd, may be added.

For example, a compound containing an additive compound may be wet-mixed with barium titanate powder, dried and pulverized to prepare a ceramic material in which barium titanate powder and the additive compound are mixed. For example, if necessary, the ceramic material obtained as described above may be pulverized to adjust the particle diameter, or may be combined with a classification process to adjust the particle diameter. Specifically, along with the ceramic material, beads with a diameter of 0.1 mm to 3 mm made of yttrium-stabilized zirconia, alumina, or silicon nitride may be stirred for 10 to 100 hours in order to adjust the particle diameter. Through the above steps, a dielectric ceramic composition is obtained.

### (Coating Process)

Next, a binder such as polyvinyl butyral (PVB) resin, an organic solvent such as ethanol or toluene, and a plasticizer are added to the obtained dielectric ceramic composition and wet-mixed. Using the obtained slurry, a ceramic green sheet 51 is coated on a base material by, for example, a die coater method or a doctor blade method, and then dried. The base material is, for example, a polyethylene terephthalate (PET) film. Figures illustrating the coating process are omitted.

### (Internal Electrode Formation Process)

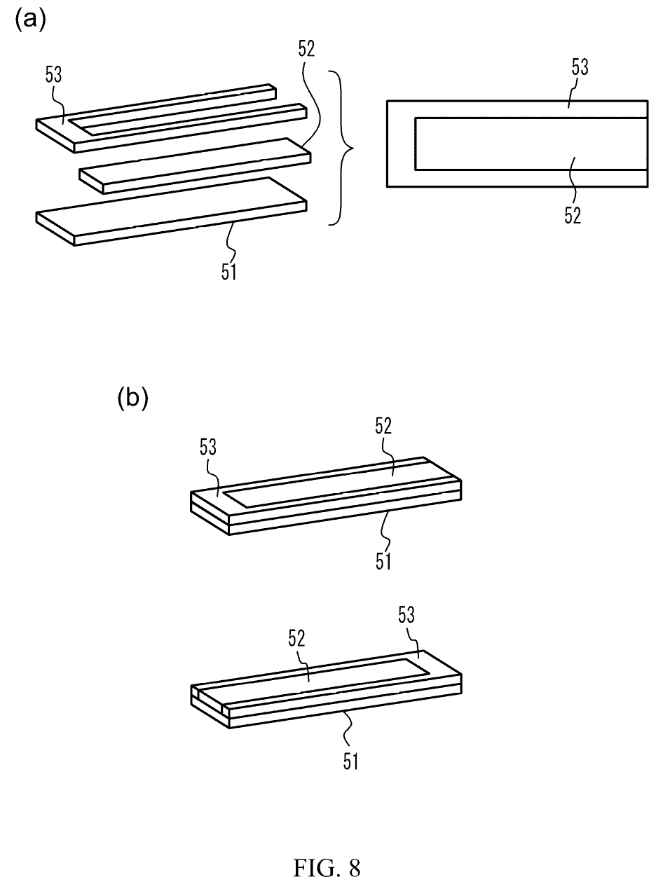

Next, as illustrated in FIG. 8(a), a metal conductive paste containing an organic binder for forming internal electrodes is printed on the surface of the ceramic green sheet 51 by screen printing, gravure printing, etc., to form internal electrode patterns 52 that are to be arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium titanate having an average particle diameter of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 8(a), on the ceramic green sheet 51, the dielectric pattern 53 is arranged by printing a dielectric pattern paste in the peripheral area where the internal electrode pattern 52 is not printed so as to arrange the internal electrode pattern 53, thereby filling in a step with the internal electrode pattern 52. The ceramic green sheet 51 on which the internal electrode pattern 52 and the dielectric pattern 53 are printed is referred to as a lamination unit.

Thereafter, as illustrated in FIG. 8(b), the lamination unites are stacked such that the internal electrode layers 12 and the dielectric layers 11 are arranged alternately, and that the edges of the internal electrode layers 12 are alternately exposed and drawn out alternately to a pair of external electrodes 20a and 20b having different polarities. For example, the number of stacked layers of the internal electrode pattern 52 is set to 100 to 1000 layers.

### (Crimping Process)

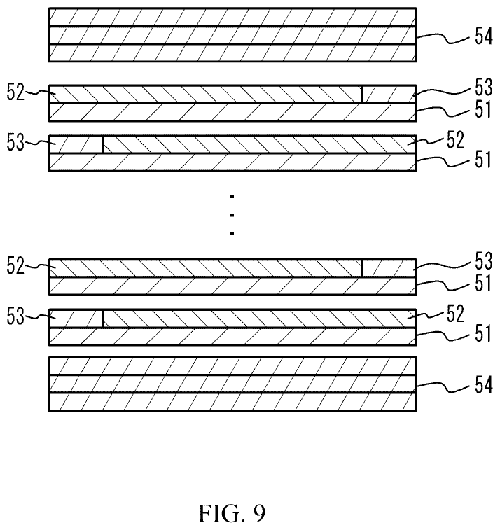

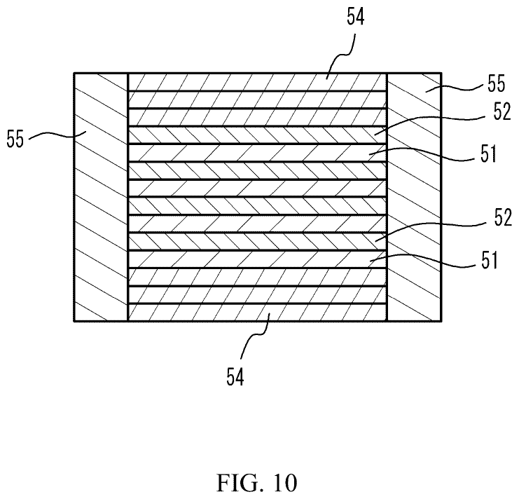

As illustrated in FIG. 9, a predetermined number (for example, 2 to 10 layers) of cover sheets 54 are laminated on top and bottom of the laminate, in which the lamination units have been laminated, and are bonded by thermocompression. As an example of the ceramic material for the cover sheet 54, the dielectric ceramic composition described above can be used. Thereafter, it is cut into a predetermined chip size (for example, 1.0 mm×0.5 mm). Here, the side margin portions may be attached or coated on the side surfaces of the laminate instead. Specifically, as illustrated in FIG. 10, a laminated body may be obtained by alternately laminating ceramic green sheets 51 and internal electrode patterns 52 that have the same width as the ceramic green sheets 51. Then, sheets formed of dielectric pattern paste may be attached as the side margin portions 55 to the side surfaces of the laminated body, respectively.

### (Firing Process)

After debinding the ceramic laminate thus obtained in an N₂ atmosphere, air atmosphere, etc., a metal paste that will become the base layer of the external electrodes 20a, 20b is applied by a dip method, and the resulting laminate is fired in a reducing atmosphere of an oxygen partial pressure of 10⁻¹² atm 10⁻⁹ atm at 1100° C. to 1300° C. for 10 minutes to 2 hours. In this manner, the multilayer ceramic capacitor 100 is being obtained. Note that in the firing step, the temperature is rapidly raised. The temperature increase rate in the firing step is, for example, 6000° C./h. Thereby, the second crystal grains 42 do not become huge particles, and furthermore, the time required for firing can be substantially shortened, and higher mass productivity can be achieved.

### (Re-Oxidation Treatment Process)

Thereafter, reoxidation treatment may be performed at 600° C. to 1000° C. in an N₂ gas atmosphere.

### (Plating Process)

Thereafter, a metal coating such as Cu, Ni, Sn, etc., is performed on the base layer of the external electrodes 20a, 20b by plating. Through the above steps, the multilayer ceramic capacitor 100 is completed.

According to the manufacturing method of the present embodiment, the first crystal grains 41 illustrated in FIG. 2 and the second crystal grains 42 are included in at least part of the dielectric layer 11 of the capacitance region 14. Therefore, in multilayer ceramic capacitors for which high mass productivity is required, the rate of change in capacitance due to changes in firing temperature can be suppressed and high mass productivity can be achieved.

The firing temperature dependence (Δε/° C.) of the relative permittivity due to changes in the firing temperature of the multilayer ceramic capacitor 100 is evaluated by the following method. First, capacitance Cp (nF) and direct current I (nA) are measured for the multilayer ceramic capacitor 100 that has undergone the firing process, the reoxidation process, and the plating process. Next, in the multilayer ceramic capacitor 100, the capacitance region 14 is exposed by cutting or polishing, etc., on the A-A line cross section and the B-B line cross section illustrated in FIGS. 5 and 6, and the exposed surfaces are polished using a diamond paste of 2 μm or less or the like to achieve a smoothness that can be considered as a mirror surface. The effective area of the internal electrode layer is evaluated using these surfaces.

The Effective Area S is Determined from the Length L and the Number N of the Internal Electrode Layers 12 in the Capacitance Region 14 in FIG. 5, and the Width W of the Internal Electrode Layers 12 in the Capacitance Region 14 in FIG. 6, as Follows: S=L×W×(N−1)

At this time, the thickness of each dielectric layer 11 is also measured, and the average thickness t is calculated. Here, the relative dielectric constant F can be calculated according to ε=(Cp×t/S)/ε₀ with the vacuum permittivity: ε₀=8.8542×10⁻¹² F/m.

Further, the DC resistivity ρ(Ω·cm) can be calculated according to ρ=(V/I)×(S/t), where the DC voltage at the time of measurement is V (V).

Regarding the capacitance Cp, it is generally preferable to measure it using an LCR meter. In the measurement, it is necessary to determine the measurement frequency and measurement voltage, but it is preferable that the measurement voltage is determined as a measurement electric field depending on the thickness of the dielectric layer 11. In this embodiment, the capacitance Cp is measured at a room temperature of 25° C. with a measurement frequency of 1 kHz and a measurement electric field of 0.5 Vrms/μm, that is, when the thickness of the dielectric layer 11 is 2 μm, 1 Vrms is applied to measure the capacitance Cp.

As for the direct current I, it is generally preferable to measure it using an insulation resistance meter. In the measurement, it is necessary to determine the measurement voltage, but it is preferable to determine the measurement electric field depending on the thickness of the dielectric layer 11. In this embodiment, the multilayer ceramic capacitor 100 is kept in a constant temperature chamber at 150° C. for 30 minutes, insulation from the surroundings is ensured using a ceramic insulator, etc., and the DC current is measured by applying a measurement electric field of 30 V/km (for example, 60 V for 30 seconds if the thickness of the dielectric layer 11 is 2 km) through the wires connected to the external electrodes 20a and 20b so as to calculate the DC resistivity ρ. Unless otherwise specified, the measurements are made in accordance with Japanese Industrial Standard C5101-22:2021 Fixed Capacitors for Electronic Equipment—Part 22: General Rules for Types—Fixed Multilayer Ceramic Capacitors for Surface Mounting Type 2.

Next, the DC resistivity p is measured for each of the multilayer ceramic capacitors obtained at various firing temperatures, and the firing temperature that maintains the highest resistivity is determined as the optimal firing temperature. Generally, if the firing temperature is too low, the density will be low and the resistivity will be low; if the firing temperature is too high, the ceramic particles will become larger and the number of grain boundaries will decrease, resulting in a decrease in resistivity.

Next, based on the dielectric constant F of the multilayer ceramic capacitor obtained at the firing temperature that maintains the highest resistivity and based on the measured relative permittivities of the multilayer ceramic capacitors obtained in a firing temperature range deviating from the firing temperature that maintains the highest resistivity from −20° C. to +20° C., the slope of the straight line fitting the relationship between the relative permittivities and the firing temperatures using the least squares method is obtained so as to calculate the slope of the straight line representing the firing temperature dependence of the relative permittivity (Δε/° C.) and to use it as an index for high mass productivity.

It is desirable that the DC resistivity measured at 150° C. is 2.0×10⁸ Ω·cm or more. With the resistance to 2.0×10⁸ Ω·cm or more, the multilayer ceramic capacitor 100 using the dielectric ceramic composition of this embodiment can have sufficient resistance.

It is more preferable that the DC resistivity measured at 150° C. is 1.0×10¹⁰ Ω·cm or more. By having a resistance of 1.0×10¹⁰ Ω·cm or more, the multilayer ceramic capacitor 100 using the dielectric ceramic composition of this embodiment not only has sufficient resistance, but also has a thinner profile design and can easily increase the number of internal electrodes.

It is preferable that Δε/° C. be 12 or less. With this value of or less, in the multilayer ceramic capacitor 100 using the dielectric ceramic composition of this embodiment, it is possible to achieve firing in a shorter time while suppressing changes in capacitance due to changes in firing temperature, thereby achieving high mass productivity.

Furthermore, Δε/° C. is preferably 6 or less. With this value of 6 or less, in the multilayer ceramic capacitor 100 using the dielectric ceramic composition of the present embodiment, it is possible to achieve firing in a shorter time while also suppressing changes in capacitance due to changes in firing temperature, thereby achieving higher mass productivity.

It is desirable that the dielectric constant ε is 2500 or more. Even if the DC resistivity measured at 150° C. is 2.0×10⁸ Ω·cm or more and the firing temperature dependence Δε/° C. of the relative dielectric constant is 12 or less, if ε is small, the electrostatic capacitance Cp becomes an insufficient value, resulting in characteristics unsuitable for use in the multilayer ceramic capacitor 100 using the dielectric ceramic composition.

Note that in each of the above embodiments, a multilayer ceramic capacitor has been described as an example of a multilayer ceramic electronic component, but the present invention is not limited thereto. For example, other multilayer ceramic electronic components such as varistors and thermistors may be used.

### WORKING EXAMPLES

### Working Example 1

Barium titanate powder with an average particle diameter of 150 nm was prepared, and with respect to 100 mol of barium titanate powder, 0.75 mol of Gd₂O₃, 0.5 mol of TiO₂, 1.5 mol of MnCO₃, and 1.0 mol of SiO₂ were added to obtain a dielectric ceramic composition. The Ba/Ti element ratio was set to 0.995.

A dielectric slurry was prepared by mixing the dielectric ceramic composition with ethanol, toluene, and PVB (polyvinyl butyral) resin. This slurry was formed into a ceramic green sheet using a die coater. After drying this ceramic green sheet, nickel paste was printed to form an internal electrode pattern. The obtained lamination units were laminated, and thick layers of ceramic green sheets on which no internal electrode pattern was formed were crimped on top and bottom of the laminate, and then cut into small pieces. Thereafter, Ni paste was applied on the two end faces as a conductive paste for external electrodes by dipping, and degreasing was performed in a nitrogen gas atmosphere. The degreased piece was fired and sintered in a reducing atmosphere controlled to have an oxygen partial pressure that would not oxidize nickel. The firing temperature was 1220° C.

The size of the resulting multilayer ceramic capacitor thus far was in the 1005 shape (1.0 mm×1.0 mm×0.5 mm). Thereafter, reoxidation treatment was performed at 950° C. Thereafter, plating was performed to form a Cu plating layer, a Ni plating layer, and a Sn plating layer on the surface of the base layer, thereby obtaining a multilayer ceramic capacitor. The average thickness of the dielectric layer 11 was 2.0 μm.

### Working Example 2

In Working Example 2, 0.75 mol of Gd₂O₃, 1.0 mol of TiO₂, 1.5 mol of MnCO₃, and 1.0 mol of SiO₂ were added with respect to 100 mol of barium titanate powder to obtain a dielectric ceramic composition. The Ba/Ti element ratio was set to 0.990. The firing temperature was 1230° C. Other conditions were the same as in Working Example 1.

### Working Example 3

In Working Example 3, 0.75 mol of Gd₂O₃, 2.0 mol of TiO₂, 1.5 mol of MnCO₃, and 1.0 mol of SiO₂ were added with respect to 100 mol of barium titanate powder to obtain a dielectric ceramic composition. The Ba/Ti element ratio was set to 0.980. The firing temperature was 1240° C. Other conditions were the same as in Working Example 1.

### Working Example 4

In Working Example 4, 0.75 mol of Gd₂O₃, 4.0 mol of TiO₂, 1.5 mol of MnCO₃, and 1.0 mol of SiO₂ were added with respect to 100 mol of barium titanate powder to obtain a dielectric ceramic composition. The Ba/Ti element ratio was set to 0.962. The firing temperature was 1270° C. Other conditions were the same as in Working Example 1.

### Working Example 5

In Working Example 5, 0.75 mol of Gd₂O₃, 8.0 mol of TiO₂, 1.5 mol of MnCO₃, and 1.0 mol of SiO₂ were added with respect to 100 mol of barium titanate powder to obtain a dielectric ceramic composition. The Ba/Ti element ratio was 0.926. The firing temperature was 1270° C. Other conditions were the same as in Working Example 1.

### Comparative Example 1

In Comparative Example 1, with respect to 100 mol of barium titanate powder, Gd₂O₃ was not added, and 1.5 mol of TiO₂, 1.5 mol of MnCO₃, and 1.0 mol of SiO₂ were added to prepare a dielectric ceramic composition. The Ba/Ti element ratio was 0.985. The firing temperature was 1220° C. Other conditions were the same as in Working Example 1.

### Comparative Example 2

In Comparative Example 2, 0.75 mol of Gd₂O₃, 0.2 mol of TiO₂, 1.5 mol of MnCO₃, and 1.0 mol of SiO₂ were added with respect to 100 mol of barium titanate powder to obtain a dielectric ceramic composition. The Ba/Ti element ratio was 0.998. The firing temperature was 1210° C. Other conditions were the same as in Working Example 1.

For each of the multilayer ceramic capacitors of Working Examples 1 to 5 and Comparative Examples 1 and 2, capacitance Cp was measured at room temperature (25° C.) at 1 kHz and 1 Vrms using an LCR meter, and the direct current I was measured at 150° C. by applying 60 V for 30 seconds using an insulation resistance meter. Further, the effective area S of the internal electrode layers and the average thickness t of the dielectric layers were calculated by exposing the cross section along the line A-A and the cross section along the line B-B in FIG. 4. The relative permittivity ε and the resistivity ρ were calculated from the effective area S and the average thickness t. Then, the resistivities ρ of each multilayer ceramic capacitor of Working Examples 1 to 5 and Comparative Examples 1 and 2 were compared, and by referring to the dielectric constants of the multilayer ceramic capacitors fired at a temperature range from −20° C. to +20° C. from the firing temperature at which the multilayer ceramic capacitor had the highest resistivity and by obtaining the slope of the relationship between the firing temperature and the dielectric constants using the least square method, a firing temperature dependency of the dielectric constant (Δε/° C.) was obtained.

Furthermore, a conductive substance such as osmium was deposited on the exposed dielectric layer, and a photograph of the crystal grains present in the dielectric layer was taken by SEM observation. Then, the average particle diameter of the crystal grains constituting the dielectric layer was calculated.

In addition, during SEM observation of the multilayer ceramic capacitor, the presence of second crystal grains 42 was evaluated in the BSE image based on the difference in brightness. With respect to parts that are observed dark with relatively low brightness, whether or not the crystal grain is made of barium titanate complex oxide with an elemental ratio v of barium to titanium of 0.70 or less was determined using the EDS composition evaluation method. In addition, the element ratio of manganese to titanium was also evaluated for that part, and whether the element ratio w of Mn/Ti satisfied 0.02≤w≤0.10 was evaluated.

For each multilayer ceramic capacitor, in order to confirm the composition of the shell portion and core portion of the crystal grains of the dielectric layer, a sample was cut out using FIB for EDS observation using TEM, and a composition evaluation method using EDS was performed to determine whether it had a core-shell structure.

In addition, for each multilayer ceramic capacitor exemplary samples, the cover layers, end margins, side margins, and external electrodes, which are outside the capacitance section, were removed by polishing or cutting, and then the dielectric layer that constitutes the capacitance region was crushed to obtain powder. The diffraction profile of the powder was then measured using an X-ray diffractometer (XRD) using Cu-Kα rays so as to evaluate whether there were second crystal grains 42 that could be identified as Ba₄Ti₁₁O₂₆.

Table 1 summarizes the amounts of additives added in Comparative Examples 1 and 2 and Working Examples 1 to 5, as well as the firing temperature, average particle diameter, ε, Δε/° C.,

and resistivity at 150° C.

TABLE 1

| | | | | | | | | Average | | | |
|---|---|---|---|---|---|---|---|---|---|---|---|
| | Addition amount per 100 mol BaTiO₃ | | | | | Ba/Ti | Firing | particle | | | Resistivity |
| | (mol) | | | | | Element | temperature | diameter | | | @150° C. |
| | Gd₂O₃ | TiO₂ | MnCO₃ | SiO₂ | MgO | ratio | (° C.) | (nm) | ε | Δε/° C. | Ω · cm |
| Comparative | 0 | 1.5 | 1.5 | 1.0 | 0.0 | 0.985 | 1220 | 2400 | 2820 | 1.0 | — |
| Example 1 | | | | | | | | | | | |
| Comparative | 0.75 | 0.2 | 1.5 | 1.0 | 0.0 | 0.998 | 1210 | 520 | 4400 | 12.5 | 2.6 × 10¹⁰ |
| Example 2 | | | | | | | | | | | |
| Working | 0.75 | 0.5 | 1.5 | 1.0 | 0.0 | 0.995 | 1220 | 450 | 3930 | 10.0 | 2.0 × 10¹⁰ |
| Example 1 | | | | | | | | | | | |
| Working | 0.75 | 1.0 | 1.5 | 1.0 | 0.0 | 0.990 | 1230 | 430 | 3830 | 2.5 | 1.4 × 10¹⁰ |
| Example 2 | | | | | | | | | | | |
| Working | 0.75 | 2.0 | 1.5 | 1.0 | 0.0 | 0.980 | 1240 | 380 | 3630 | 0.8 | 6.9 × 10⁹ |
| Example 3 | | | | | | | | | | | |
| Working | 0.75 | 4.0 | 1.5 | 1.0 | 0.0 | 0.962 | 1270 | 290 | 3200 | 0.3 | 1.4 × 10⁹ |
| Example 4 | | | | | | | | | | | |
| Working | 0.75 | 8.0 | 1.5 | 1.0 | 0.0 | 0.926 | 1270 | 270 | 2520 | 1.5 | 3.5 × 10⁸ |
| Example 5 | | | | | | | | | | | |

Comparative Example 1 is a comparative example in which gadolinium is not included as a rare earth element. Comparative Example 2 is a comparative example in which the amount of TiO₂ added is small—i.e., at the lower limit. In Comparative Example 1, since gadolinium was not included as a rare earth element, the particle diameter could not be controlled during firing and the particle diameter grew to 2400 nm, resulting in a low resistance. In Comparative Example 2, since gadolinium was contained as a rare earth element, the average particle diameter was 520 nm, and the resistivity at 150° C. was 2.6×10¹⁰ Ω·cm, making it possible to maintain sufficient resistivity. However, since a sufficient amount of TiO₂ was not added, the value of Δε/° C. was 12.5, not reaching a preferable value of 12 or less.

In Working Examples 1 to 5, the amount of TiO₂ added was 0.5 mol to 8.0 mol per 100 mol of BaTiO₃, and the Ba/Ti element ratio x in the dielectric layer was in the 0.926≤x≤0.995 range. In this range, the value of Δε/° C. was 12 or less. In particular, when the amount of TiO₂ added was 1.0 mol or more, Δε/° C. was 3 or less. For example, even when using a larger firing furnace than existing firing furnaces to increase productivity efficiency, the distribution of the relative dielectric constant caused by the temperature distribution within the furnace—that is, the distribution of the capacitance Cp within the furnace—did not have a large distribution. For this reason, even in short-time firing due to rapid temperature rise, it is possible to achieve greater mass production. Furthermore, since the average particle diameter was 500 nm or less and the resistivity was 2.0×10⁸ Ω·cm or more, a preferable electrical life was obtained.

In order to investigate the mechanism of the dielectric layers in detail, for each of the multilayer ceramic capacitors obtained in Working Examples 1 to 5 and Comparative Examples 1 and 2, TEM-EDS, SEM-EDS, and XRD measurements were performed to determine whether a core-shell structure exists, whether Ba₄Ti₁₁O₂₆ exists, whether the elemental ratio v of Ba to Ti in the second crystal grain 42 is in the range of 0.16≤v≤0.70, and whether the elemental ratio w of Mn to Ti is in the range of 0.02≤w≤0.10. The results are summarized in Table 2.

TABLE 2

| | | Shell | | Core | | | Second crystal grain | |
|---|---|---|---|---|---|---|---|---|
| | | Gd/Ti | Mn/Ti | Gd/Ti | Mn/Ti | | Ba/Ti | Mn/Ti |
| | Core shell | Element | Element | Element | Element | Ba₄/Ti₁₁O₂₈ | Element | Element |
| | existed? | ratio | ratio | ratio | ratio | found? | ratio | ratio |
| Comparative | No | — | 0.011 | — | 0.004 | Yes | 0.45 | 0.03 |
| Example 1 | | | | | | | | |
| Comparative | Yes | 0.031 | 0.035 | 0.001 | 0.004 | No | — | — |
| Example 2 | | | | | | | | |
| Working | Yes | 0.028 | 0.022 | 0.000 | 0.002 | Yes | 0.58 | 0.03 |
| Example 1 | | | | | | | | |
| Working | Yes | 0.025 | 0.026 | 0.000 | 0.004 | Yes | 0.52 | 0.05 |
| Example 2 | | | | | | | | |
| Working | Yes | 0.023 | 0.029 | 0.000 | 0.000 | Yes | 0.43 | 0.02 |
| Example 3 | | | | | | | | |
| Working | Yes | 0.025 | 0.021 | 0.000 | 0.001 | Yes | 0.49 | 0.03 |
| Example 4 | | | | | | | | |
| Working | Yes | 0.027 | 0.023 | 0.000 | 0.002 | Yes | 0.29 | 0.05 |
| Example 5 | | | | | | | | |

In Comparative Example 1, a core-shell structure was not found because it did not contain gadolinium, which is a rare earth element. In addition, the Mn/Ti ratio of the shell in Comparative Example 1 is the Mn/Ti ratio measured at point C in FIG. 3, and the Mn/Ti ratio of the core is the Mn/Ti ratio measured at the midpoint M in FIG. 3. In Comparative Example 2, since the amount of TiO₂ added was insufficient, the presence of Ba₄Ti₁₁O₂₆ could not be revealed by XRD measurement. Further, in SEM-EDS, it was not possible to confirm the presence of second crystal particles 42, which would be observed darkly and would have a relatively low brightness with respect to the main crystal particles made of barium titanate.

On the other hand, in Working Examples 1 to 5, it was determined that a core-shell structure existed, Ba₄Ti₁₁O₂₆ was present in XRD, and the elemental ratio v of Ba to Ti and the elemental ratio w of Mn to Ti in the second crystal grains 42 were in the range of 0.16≤v≤0.70 and 0.02≤w≤0.10, respectively, so the presence of the second crystal grains 42 was also evident. Furthermore, as shown in Table 1, the value of Δε/° C. is 12 or less, the resistivity is 2.0×10⁸ Ω·cm or more, the average particle diameter is 500 nm or less, and the dielectric constant satisfied ε>2500 or more.

In order to verify whether similar effects are obtained when the rare earth type, rare earth amount, manganese amount, silicon amount, and magnesium amount of the dielectric ceramic composition are controlled, multilayer ceramic capacitors made of the above-described dielectric ceramic composition were produced as working examples within the scope of the present invention using the same work procedures as those of Comparative Examples 1 and 2 and Working Examples 1 to 5.

### Verification of the Effect of Changing the Rare Earth Type

### Working Example 6

In Working Example 6, 0.75 mol of Eu₂O₃ (europium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1280° C. The other conditions were the same as in Working Example 1.

### Working Example 7

In Working Example 7, 0.75 mol of Tb₂O₃ (terbium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1260° C. The other conditions were the same as those in Working Example 1.

### Working Example 8

In Working Example 8, 0.75 mol of Dy₂O₃ (dysprosium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1260° C. The other conditions were the same as those in Working Example 1.

### Working Example 9

In Working Example 9, 0.75 mol of Y₂O₃ (yttrium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1260° C. The other conditions were the same as those of Working Example 1.

### Working Example 10

In Working Example 10, 0.75 mol of Ho₂O₃ (holmium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1250° C. The other conditions were the same as those in Working Example 1.

### Working Example 11

In Working Example 11, 0.75 mol of Er₂O₃ (erbium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1250° C. The other conditions were the same as those of Working Example 1.

### Working Example 12

In Working Example 12, 0.75 mol of Yb₂O₃ (ytterbium oxide), 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1250° C. The other conditions were the same as those of Working Example 1.

### Working Example 13

In Working Example 13, 0.375 mol of Gd₂O₃, 0.375 mol of Dy₂O₃, 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1260° C. The other conditions were the same as those of Working Example 1.

### Working Example 14

In Working Example 14, 0.375 mol of Eu₂O₃, 0.375 mol of Ho₂O₃, 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1270° C. The other conditions were the same as those of Working Example 1.

### Working Example 15

In Working Example 15, 0.25 mol of Gd₂O₃, 0.25 mol of Tb₂O₃, 0.25 mol of Y₂O₃, 4.0 mol of TiO₂, 1.5 mol of MnCO₃, and 1.0 mol of SiO₂ were added to 100 mol of barium titanate powder to obtain a dielectric ceramic composition. The Ba/Ti element ratio was 0.962. The firing temperature was 1250° C. The other conditions were the same as those of Working Example 1.

Working Examples 6 to 12 are cases where the rare earth type is changed to europium, terbium, dysprosium, holmium, erbium, and ytterbium, and Working Examples 13 to 15 are working examples of dielectric ceramic compositions where two or more elements selected from the rare earth elements are added.

In Working Examples 6 to 15, the value of Δε/° C. was 2 or less, and it was found that the relative dielectric constant was sufficiently stable against the firing temperature. Furthermore, the average particle diameter was 500 nm or less, and the resistivity at 150° C. was 2.0×10⁸ Ω·cm or more. Therefore, even with firing in a short time by rapid temperature rise, mass production is possible, and sufficient reliability can be obtained.

### Verification of the Effect of the Amount of MnCO₃ Added

### Working Example 16

In Working Example 16, 0.75 mol of Gd₂O₃, 4.0 mol of TiO₂, 0.2 mol of MnCO₃, and 1.0 mol of SiO₂ were added with respect to 100 mol of barium titanate powder to obtain a dielectric ceramic composition. The Ba/Ti element ratio was set to 0.962. The firing temperature was 1280° C. Other conditions were the same as in Working Example 1.

### Working Example 17

In Working Example 17, 0.75 mol of Gd₂O₃, 4.0 mol of TiO₂, 1.0 mol of MnCO₃, and 1.0 mol of SiO₂ were added with respect to 100 mol of barium titanate powder to obtain a dielectric ceramic composition. The Ba/Ti element ratio was set to 0.962. The firing temperature was 1280° C. Other conditions were the same as in Working Example 1.

### Working Example 18

In Working Example 18, 0.75 mol of Gd₂O₃, 4.0 mol of TiO₂, 2.0 mol of MnCO₃, and 1.0 mol of SiO₂ were added with respect to 100 mol of barium titanate powder to obtain a dielectric ceramic composition. The Ba/Ti element ratio was set to 0.962. The firing temperature was 1230° C. Other conditions were the same as in Working Example 1.

### Working Example 19

In Working Example 19, 0.75 mol of Gd₂O₃, 4.0 mol of TiO₂, 5.0 mol of MnCO₃, and 1.0 mol of SiO₂ were added with respect to 100 mol of barium titanate powder to obtain a dielectric ceramic composition. The Ba/Ti element ratio was set to 0.962. The firing temperature was 1210° C. Other conditions were the same as in Working Example 1.

Working Examples 16 to 19 are working examples of dielectric ceramic compositions in which the amount of MnCO₃ added was varied in the range of 0.2 mol to 5.0 mol per 100 mol of BaTiO₃. In Working Examples 16 to 19, the value of Δε/° C. was found to be 12 or less. In particular, when the amount of MnCO₃ added was in the range of 1.0 mol to 5.0 mol, Δε/° C. was 4 or less. Moreover, the average particle diameter was also 500 nm or less, and the resistivity was also 2.0×10⁸ Ω·cm or more. Therefore, even when using a larger firing furnace than existing firing furnaces in order to increase productivity efficiency, for example, the relative dielectric constant obtained with respect to the temperature distribution in the furnace, that is, the value of capacitance Cp, does not have a large distribution. Therefore, even in short-time firing due to rapid temperature rise, it is possible to achieve mass production and to obtain sufficient reliability.

### Verification of the Effect of the Amount of MgO Added

### Working Example 20

In Working Example 20, 0.75 mol of Gd₂O₃, 4.0 mol of TiO₂, 1.5 mol of MnCO₃, 1.0 mol of SiO₂, and 0.05 mol of MgO were added with respect to 100 mol of barium titanate powder to obtain a dielectric ceramic composition. The Ba/Ti element ratio was set to 0.962. The firing temperature was 1270° C. Other conditions were the same as in Working Example 1.

### Working Example 21

In Working Example 21, 0.75 mol of Gd₂O₃, 4.0 mol of TiO₂, 1.5 mol of MnCO₃, 1.0 mol of SiO₂, and 0.2 mol of MgO were added with respect to 100 mol of barium titanate powder to obtain a dielectric ceramic composition. The Ba/Ti element ratio was set to 0.962. The firing temperature was 1290° C. Other conditions were the same as in Working Example 1.

### Working Example 22

In Working Example 22, 0.75 mol of Gd₂O₃, 4.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.962. The firing temperature was 1270° C. Other conditions were the same as in Working Example 1.

### Working Example 23

In Working Example 23, 0.75 mol of Gd₂O₃, 4.0 mol of TiO₂, 1.5 mol of MnCO₃, 1.0 mol of SiO₂, and 1.0 mol of MgO were added with respect to 100 mol of barium titanate powder to obtain a dielectric ceramic composition. The Ba/Ti element ratio was set to 0.962. The firing temperature was 1260° C. Other conditions were the same as in Working Example 1.

### Working Example 24

In Working Example 24, 0.75 mol of Gd₂O₃, 4.0 mol of TiO₂, 1.5 mol of MnCO₃, 1.0 mol of SiO₂, and 2.0 mol of MgO were added with respect to 100 mol of barium titanate powder to obtain a dielectric ceramic composition. The Ba/Ti element ratio was set to 0.962. The firing temperature was 1240° C. Other conditions were the same as in Working Example 1.

### Working Example 25

In Working Example 25, 0.75 mol of Gd₂O₃, 4.0 mol of TiO₂, 1.5 mol of MnCO₃, 1.0 mol of SiO₂, and 5.0 mol of MgO were added with respect to 100 mol of barium titanate powder to obtain a dielectric ceramic composition. The Ba/Ti element ratio was set to 0.962. The firing temperature was 1230° C. Other conditions were the same as in Working Example 1.

Working Examples 20 to 25 are working examples of dielectric ceramic compositions in which the amount of MgO added was varied from 0.05 mol to 5.0 mol per 100 mol of BaTiO₃.

In Working Examples 20 to 25, the value of Δε/° C. was 2 or less, indicating that the dielectric constant was sufficiently stable with respect to the firing temperature. Further, the average particle diameter was 500 nm or less, and the resistivity was 2.0×10⁸ Ω·cm or more. Therefore, even when using a larger firing furnace than existing firing furnaces in order to increase productivity efficiency, for example, the relative dielectric constant obtained with respect to the temperature distribution in the furnace, that is, the capacitance Cp, does not have a large distribution. Therefore, even in short-time firing due to rapid temperature rise, it is possible to achieve mass production and to obtain sufficient reliability.

### Verification of the Effect of the Amount of Gd₂O₃ Added

### Working Example 26

In Working Example 26, 0.25 mol of Gd₂O₃, 4.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.962. The firing temperature was 1280° C. Other conditions were the same as in Working Example 1.

### Working Example 27

In Working Example 27, 1.0 mol of Gd₂O₃, 4.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.962. The firing temperature was 1250° C. Other conditions were the same as in Working Example 1.

### Working Example 28

In Working Example 28, 2.5 mol of Gd₂O₃, 4.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.962. The firing temperature was 1230° C. Other conditions were the same as in Working Example 1.

Working Examples 26 to 28 are working examples of dielectric ceramic compositions in which the amount of Gd₂O₃ added was varied in the range of 0.25 mol to 2.5 mol per 100 mol of BaTiO₃.

In Working Examples 26 to 28, the value of Δε/° C. was 2 or less, indicating that the dielectric constant was sufficiently stable with respect to the firing temperature. Furthermore, the average particle diameter was also 500 nm or less, and the resistivity at 150° C. was also 2.0×10⁸ Ω·cm or more. Therefore, even in short-time firing due to rapid temperature rise, it is possible to achieve higher mass production and to obtain sufficient reliability.

### Working Example 29

In Working Example 29, 0.25 mol of Eu₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1290° C. The other conditions were the same as those of Working Example 1.

### Working Example 30

In Working Example 30, 2.5 mol of Eu₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1260° C. The other conditions were the same as those of Working Example 1.

### Working Example 31

In Working Example 31, 0.25 mol of Tb₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1280° C. The other conditions were the same as those of Working Example 1.

### Working Example 32

In Working Example 32, 2.5 mol of Tb₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1260° C. The other conditions were the same as those of Working Example 1.

### Working Example 33

In Working Example 33, 0.25 mol of Dy₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1270° C. The other conditions were the same as those of Working Example 1.

### Working Example 34

In Working Example 34, 2.5 mol of Dy₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1250° C. The other conditions were the same as those of Working Example 1.

### Working Example 35

In Working Example 35, 0.25 mol of Y₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1270° C. The other conditions were the same as those of Working Example 1.

### Working Example 36

In Working Example 36, 2.5 mol of Y₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1240° C. The other conditions were the same as those of Working Example 1.

### Working Example 37

In Working Example 37, 0.25 mol of Ho₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1260° C. The other conditions were the same as those of Working Example 1.

### Working Example 38

In Working Example 38, 2.5 mol of Ho₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1240° C. The other conditions were the same as those of Working Example 1.

### Working Example 39

In Working Example 39, 0.25 mol of Er₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1260° C. The other conditions were the same as those of Working Example 1.

### Working Example 40

In Working Example 40, 2.5 mol of Er₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1240° C. The other conditions were the same as those of Working Example 1.

### Working Example 41

In Working Example 41, 0.25 mol of Yb₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1260° C. The other conditions were the same as those of Working Example 1.

### Working Example 42

In Working Example 42, 2.5 mol of Yb₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1240° C. The other conditions were the same as those of Working Example 1.

### Working Example 43

In Working Example 43, 0.125 mol of Gd₂O₃, 0.125 mol of Dy₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1270° C. The other conditions were the same as those of Working Example 1.

### Working Example 44

In Working Example 44, 1.25 mol of Gd₂O₃, 1.25 mol of Dy₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1250° C. The other conditions were the same as those of Working Example 1.

### Working Example 45

In Working Example 45, 0.125 mol of Eu₂O₃, 0.125 mol of Ho₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1270° C. The other conditions were the same as those of Working Example 1.

### Working Example 46

In Working Example 46, 1.25 mol of Eu₂O₃, 1.25 mol of Ho₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1240° C. The other conditions were the same as those of Working Example 1.

### Working Example 47

In Working Example 47, 0.08 mol of Gd₂O₃, 0.08 mol of Tb₂O₃, 0.09 mol of Y₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1270° C. The other conditions were the same as those of Working Example 1.

### Working Example 48

In Working Example 48, 0.8 mol of Gd₂O₃, 0.8 mol of Tb₂O₃, 0.9 mol of Y₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti element ratio was 0.962. The firing temperature was 1230° C. The other conditions were the same as those of Working Example 1.

Working Examples 26 to 48 are working examples of dielectric ceramic compositions in which the amount of rare earth element added was changed within the range of 0.25 mol to 2.5 mol per 100 mol of BaTiO₃.

In Working Examples 26 to 48, the value of Δε/° C. was 2 or less, and it was found that the relative dielectric constant was sufficiently stable against the firing temperature. Furthermore, the average particle diameter was 500 nm or less, and the resistivity at 150° C. was 2.0×10⁸ Ω·cm or more. Therefore, even with firing in a short time by rapid temperature rise, mass production can be made possible, and sufficient reliability can be obtained.

### Verification of the Effect of the Amount of SiO₂ Added

### Working Example 49

In Working Example 49, 0.75 mol of Gd₂O₃, 4.0 mol of TiO₂, 1.5 mol of MnCO₃, 0.2 mol of SiO₂, and 0.5 mol of MgO were added with respect to 100 mol of barium titanate powder to obtain a dielectric ceramic composition. The Ba/Ti element ratio was set to 0.962. The firing temperature was 1290° C. Other conditions were the same as in Working Example 1.

### Working Example 50

In Working Example 50, 0.75 mol of Gd₂O₃, 4.0 mol of TiO₂, 1.5 mol of MnCO₃, 0.5 mol of SiO₂, and 0.5 mol of MgO were added with respect to 100 mol of barium titanate powder to obtain a dielectric ceramic composition. The Ba/Ti element ratio was set to 0.962. The firing temperature was 1280° C. Other conditions were the same as in Working Example 1.

### Working Example 51

In Working Example 51, 0.75 mol of Gd₂O₃, 4.0 mol of TiO₂, 1.5 mol of MnCO₃, 2.0 mol of SiO₂, and 0.5 mol of MgO were added with respect to 100 mol of barium titanate powder to obtain a dielectric ceramic composition. The Ba/Ti element ratio was set to 0.962. The firing temperature was 1220° C. Other conditions were the same as in Working Example 1.

### Working Example 52

In Working Example 52, 0.75 mol of Gd₂O₃, 4.0 mol of TiO₂, 1.5 mol of MnCO₃, 5.0 mol of SiO₂, and 0.5 mol of MgO were added with respect to 100 mol of barium titanate powder to obtain a dielectric ceramic composition. The Ba/Ti element ratio was set to 0.962. The firing temperature was 1200° C. Other conditions were the same as in Working Example 1.

Working Examples 49 to 52 are working examples of dielectric ceramic compositions in which the amount of SiO₂ added was varied from 0.2 mol to 5.0 mol per 100 mol of BaTiO₃.

In Working Examples 49 to 52, the value of Δε/° C. was 12 or less, indicating that the dielectric constant was sufficiently stable with respect to the firing temperature. Furthermore, the average particle diameter was also 500 nm or less, and the resistivity at 150° C. was also 2.0×10⁸ Ω·cm or more. Therefore, even in short-time firing due to rapid temperature rise, it is possible to achieve higher mass production and to obtain sufficient reliability.

### Verification of the Effect of Adding Amount of TiO₂ when Adding MgO

### Working Example 53

In Working Example 53, 0.75 mol of Gd₂O₃, 1.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.990. The firing temperature was 1230° C. Other conditions were the same as in Working Example 1.

### Working Example 54

In Working Example 54, 0.75 mol of Gd₂O₃, 2.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.980. The firing temperature was 1240° C. Other conditions were the same as in Working Example 1.

### Working Example 55

In Working Example 55, 0.75 mol of Gd₂O₃, 6.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was set to 0.943. The firing temperature was 1270° C. Other conditions were the same as in Working Example 1.

### Working Example 56

In Working Example 56, 0.75 mol of Gd₂O₃, 8.0 mol of TiO₂, 1.5 mol of MnCO₃, 1.0 mol of SiO₂, and 0.5 mol of MgO were added with respect to 100 mol of barium titanate powder to obtain a dielectric ceramic composition. The Ba/Ti element ratio was 0.926. The firing temperature was 1270° C. Other conditions were the same as in Working Example 1.

TABLE 3

| | | | | | | | | | | Average | | | |
|---|---|---|---|---|---|---|---|---|---|---|---|---|---|
| | | | | | | | | Ba/Ti | Firing | particle | | | Resistivity |
| | Addition amount per 100 mol BaTiO3 (mol) | | | | | | | Element | temperature | diameter | | | @150° C. |
| | Re₂O₃ (Rare Earth Oxides) | | | TiO₂ | MnCO₃ | SiO₂ | MgO | ratio | (° C.) | (nm) | ε | (Δε/° C.) | (Ω · cm) |
| Working | Eu: 0.75 | — — | — — | 4.0 | 1.5 | 1.0 | 0.0 | 0.962 | 1280 | 280 | 3050 | 0.3 | 2.5 × 10⁸ |
| Example | | | | | | | | | | | | | |
| 6 | | | | | | | | | | | | | |
| Working | Tb: 0.75 | — — | — — | 4.0 | 1.5 | 1.0 | 0.0 | 0.962 | 1260 | 320 | 3300 | 0.4 | 3.0 × 10⁹ |
| Example | | | | | | | | | | | | | |
| 7 | | | | | | | | | | | | | |
| Working | Dy: 0.75 | — — | — — | 4.0 | 1.5 | 1.0 | 0.0 | 0.962 | 1260 | 330 | 3350 | 0.5 | 6.1 × 10⁹ |
| Example | | | | | | | | | | | | | |
| 8 | | | | | | | | | | | | | |
| Working | Y: 0.75 | — — | — — | 4.0 | 1.5 | 1.0 | 0.0 | 0.962 | 1260 | 340 | 3350 | 0.5 | 6.3 × 10⁹ |
| Example | | | | | | | | | | | | | |
| 9 | | | | | | | | | | | | | |
| Working | Ho: 0.75 | — — | — — | 4.0 | 1.5 | 1.0 | 0.0 | 0.962 | 1250 | 370 | 3180 | 0.6 | 3 × 10¹⁰ |
| Example | | | | | | | | | | | | | |
| 10 | | | | | | | | | | | | | |
| Working | Er: 0.75 | — — | — — | 4.0 | 1.5 | 1.0 | 0.0 | 0.962 | 1250 | 360 | 3150 | 0.6 | 4.7 × 10¹⁰ |
| Example | | | | | | | | | | | | | |
| 11 | | | | | | | | | | | | | |
| Working | Yb: 0.75 | — — | — — | 4.0 | 1.5 | 1.0 | 0.0 | 0.962 | 1250 | 250 | 2680 | 0.2 | 5.2 × 10¹⁰ |
| Example | | | | | | | | | | | | | |
| 12 | | | | | | | | | | | | | |
| Working | Gd: 0.375 | Dy: 0.375 | — — | 4.0 | 1.5 | 1.0 | 0.0 | 0.962 | 1260 | 300 | 3230 | 0.4 | 4.1 × 10⁹ |
| Example | | | | | | | | | | | | | |
| 13 | | | | | | | | | | | | | |
| Working | Eu: 0.375 | Ho: 0.375 | — — | 4.0 | 1.5 | 1.0 | 0.0 | 0.962 | 1270 | 330 | 3070 | 0.4 | 9.5 × 10⁸ |
| Example | | | | | | | | | | | | | |
| 14 | | | | | | | | | | | | | |
| Working | Gd: 0.25 | Tb: 0.25 | Y: 0.25 | 4.0 | 1.5 | 1.0 | 0.0 | 0.962 | 1250 | 310 | 3200 | 0.3 | 5.5 × 10¹⁰ |
| Example | | | | | | | | | | | | | |
| 15 | | | | | | | | | | | | | |
| Working | Gd: 0.75 | — — | — — | 4.0 | 0.2 | 1.0 | 0.0 | 0.962 | 1280 | 420 | 3750 | 4.3 | 2.8 × 10¹¹ |
| Example | | | | | | | | | | | | | |
| 16 | | | | | | | | | | | | | |
| Working | Gd: 0.75 | — — | — — | 4.0 | 1.0 | 1.0 | 0.0 | 0.962 | 1280 | 400 | 3520 | 3.3 | 9.2 × 10¹⁰ |
| Example | | | | | | | | | | | | | |
| 17 | | | | | | | | | | | | | |
| Working | Gd: 0.75 | — — | — — | 4.0 | 2.0 | 1.0 | 0.0 | 0.962 | 1230 | 360 | 3320 | 2.3 | 1.8 × 10¹⁰ |
| Example | | | | | | | | | | | | | |
| 18 | | | | | | | | | | | | | |
| Working | Gd: 0.75 | — — | — — | 4.0 | 5.0 | 1.0 | 0.0 | 0.962 | 1210 | 250 | 2830 | 1.3 | 1.5 × 10¹⁰ |
| Example | | | | | | | | | | | | | |
| 19 | | | | | | | | | | | | | |
| Working | Gd: 0.75 | — — | — — | 4.0 | 1.5 | 1.0 | 0.05 | 0.962 | 1270 | 300 | 3270 | 1.0 | 6.1 × 10⁹ |
| Example | | | | | | | | | | | | | |
| 20 | | | | | | | | | | | | | |
| Working | Gd: 0.75 | — — | — — | 4.0 | 1.5 | 1.0 | 0.2 | 0.962 | 1290 | 320 | 3300 | 0.8 | 8.1 × 10⁹ |
| Example | | | | | | | | | | | | | |
| 21 | | | | | | | | | | | | | |
| Working | Gd: 0.75 | — — | — — | 4.0 | 1.5 | 1.0 | 0.5 | 0.962 | 1270 | 320 | 3130 | 0.5 | 1.2 × 10¹⁰ |
| Example | | | | | | | | | | | | | |
| 22 | | | | | | | | | | | | | |
| Working | Gd: 0.75 | — — | — — | 4.0 | 1.5 | 1.0 | 1.0 | 0.962 | 1260 | 350 | 3030 | 1.3 | 2.4 × 10¹⁰ |
| Example | | | | | | | | | | | | | |
| 23 | | | | | | | | | | | | | |
| Working | Gd: 0.75 | — — | — — | 4.0 | 1.5 | 1.0 | 2.0 | 0.962 | 1240 | 350 | 2880 | 0.3 | 3.7x10¹⁰ |
| Example | | | | | | | | | | | | | |
| 24 | | | | | | | | | | | | | |
| Working | Gd: 0.75 | — — | — — | 4.0 | 1.5 | 1.0 | 5.0 | 0.962 | 1230 | 300 | 2620 | 1.0 | 3.8 × 10¹⁰ |
| Example | | | | | | | | | | | | | |
| 25 | | | | | | | | | | | | | |
| Working | Gd: 0.25 | — — | — — | 4.0 | 1.5 | 1.0 | 0.5 | 0.962 | 1280 | 270 | 3010 | 0.8 | 3.9 × 10¹⁰ |
| Example | | | | | | | | | | | | | |
| 26 | | | | | | | | | | | | | |
| Working | Gd: 1.0 | — — | — — | 4.0 | 1.5 | 1.0 | 0.5 | 0.962 | 1250 | 390 | 3410 | 0.5 | 1.1 × 10¹⁰ |
| Example | | | | | | | | | | | | | |
| 27 | | | | | | | | | | | | | |
| Working | Gd: 2.5 | — — | — — | 4.0 | 1.5 | 1.0 | 0.5 | 0.962 | 1230 | 410 | 3680 | 1.5 | 6.8 × 10⁹ |
| Example | | | | | | | | | | | | | |
| 28 | | | | | | | | | | | | | |
| Working | Eu: 0.25 | — — | — — | 4.0 | 1.5 | 1.0 | 0.5 | 0.962 | 1290 | 260 | 2950 | 0.2 | 1.0 × 10⁹ |
| Example | | | | | | | | | | | | | |
| 29 | | | | | | | | | | | | | |
| Working | Eu: 2.5 | — — | — — | 4.0 | 1.5 | 1.0 | 0.5 | 0.962 | 1260 | 330 | 3450 | 1.0 | 7.5 × 10⁸ |
| Example | | | | | | | | | | | | | |
| 30 | | | | | | | | | | | | | |
| Working | Tb: 0.25 | — — | — — | 4.0 | 1.5 | 1.0 | 0.5 | 0.962 | 1280 | 290 | 3100 | 0.2 | 6.0 × 10¹⁰ |
| Example | | | | | | | | | | | | | |
| 31 | | | | | | | | | | | | | |
| Working | Tb: 2.5 | — — | — — | 4.0 | 1.5 | 1.0 | 0.5 | 0.962 | 1260 | 420 | 3740 | 1.7 | 7.3 × 10¹⁰ |
| Example | | | | | | | | | | | | | |
| 32 | | | | | | | | | | | | | |
| Working | Dy: 0.25 | — — | — — | 4.0 | 1.5 | 1.0 | 0.5 | 0.962 | 1270 | 310 | 3200 | 0.3 | 8.3 × 10¹⁰ |
| Example | | | | | | | | | | | | | |
| 33 | | | | | | | | | | | | | |
| Working | Dy: 2.5 | — — | — — | 4.0 | 1.5 | 1.0 | 0.5 | 0.962 | 1250 | 440 | 3800 | 1.9 | 9.3 × 10¹⁰ |
| Example | | | | | | | | | | | | | |
| 34 | | | | | | | | | | | | | |
| Working | Y: 0.25 | — — | — — | 4.0 | 1.5 | 1.0 | 0.5 | 0.962 | 1270 | 320 | 3230 | 0.3 | 8.9 × 10¹⁰ |
| Example | | | | | | | | | | | | | |
| 35 | | | | | | | | | | | | | |
| Working | Y: 2.5 | — — | — — | 4.0 | 1.5 | 1.0 | 0.5 | 0.962 | 1240 | 450 | 3820 | 2.0 | 9.4 × 10¹⁰ |
| Example | | | | | | | | | | | | | |
| 36 | | | | | | | | | | | | | |
| Working | Ho: 0.25 | — — | — — | 4.0 | 1.5 | 1.0 | 0.5 | 0.962 | 1260 | 350 | 3110 | 0.5 | 9.5 × 10¹⁰ |
| Example | | | | | | | | | | | | | |
| 37 | | | | | | | | | | | | | |
| Working | Ho: 2.5 | — — | — — | 4.0 | 1.5 | 1.0 | 0.5 | 0.962 | 1240 | 470 | 3580 | 2.2 | 3.5 × 10¹¹ |
| Example | | | | | | | | | | | | | |
| 38 | | | | | | | | | | | | | |
| Working | Er: 0.25 | — — | — — | 4.0 | 1.5 | 1.0 | 0.5 | 0.962 | 1260 | 340 | 3010 | 0.5 | 1.6 × 10¹¹ |
| Example | | | | | | | | | | | | | |
| 39 | | | | | | | | | | | | | |
| Working | Er: 2.5 | — — | — — | 4.0 | 1.5 | 1.0 | 0.5 | 0.962 | 1240 | 450 | 3140 | 2.3 | 4.9 × 10¹¹ |
| Example | | | | | | | | | | | | | |
| 40 | | | | | | | | | | | | | |
| Working | Yb: 0.25 | — — | — — | 4.0 | 1.5 | 1.0 | 0.5 | 0.962 | 1260 | 270 | 2320 | 0.2 | 3.3 × 10¹¹ |
| Example | | | | | | | | | | | | | |
| 41 | | | | | | | | | | | | | |
| Working | Yb: 2.5 | — — | — — | 4.0 | 1.5 | 1.0 | 0.5 | 0.962 | 1240 | 230 | 2130 | 0.1 | 5.1 × 10¹¹ |
| Example | | | | | | | | | | | | | |
| 42 | | | | | | | | | | | | | |
| Working | Gd: 0.125 | Dy: 0.125 | — — | 4.0 | 1.5 | 1.0 | 0.5 | 0.962 | 1270 | 290 | 3140 | 0.5 | 7.7 × 10¹⁰ |
| Example | | | | | | | | | | | | | |
| 43 | | | | | | | | | | | | | |
| Working | Gd: 1.25 | Dy: 1.25 | — — | 4.0 | 1.5 | 1.0 | 0.5 | 0.962 | 1250 | 420 | 3540 | 1.6 | 1.5 x 10¹⁰ |
| Example | | | | | | | | | | | | | |
| 44 | | | | | | | | | | | | | |
| Working | Eu: 0.125 | Ho: 0.125 | — — | 4.0 | 1.5 | 1.0 | 0.5 | 0.962 | 1270 | 330 | 3040 | 0.4 | 5.5 × 10⁹ |
| Example | | | | | | | | | | | | | |
| 45 | | | | | | | | | | | | | |
| Working | Eu: 1.25 | Ho: 1.25 | — — | 4.0 | 1.5 | 1.0 | 0.5 | 0.962 | 1240 | 420 | 3300 | 0.7 | 4.9 × 10⁹ |
| Example | | | | | | | | | | | | | |
| 46 | | | | | | | | | | | | | |
| Working | Gd: 0.08 | Tb: 0.08 | Y: 0.09 | 4.0 | 1.5 | 1.0 | 0.5 | 0.962 | 1270 | 300 | 3180 | 0.3 | 7.1 × 10¹⁰ |
| Example | | | | | | | | | | | | | |
| 47 | | | | | | | | | | | | | |
| Working | Gd: 0.8 | Tb: 0.8 | Y: 0.9 | 4.0 | 1.5 | 1.0 | 0.5 | 0.962 | 1230 | 430 | 3760 | 1.2 | 5.7 × 10¹⁰ |
| Example | | | | | | | | | | | | | |
| 48 | | | | | | | | | | | | | |
| Working | Gd: 0.75 | — — | — — | 4.0 | 1.5 | 0.2 | 0.5 | 0.962 | 1290 | 340 | 3400 | 3.0 | 8.5 × 10¹⁰ |
| Example | | | | | | | | | | | | | |
| 49 | | | | | | | | | | | | | |
| Working | Gd: 0.75 | — — | — — | 4.0 | 1.5 | 0.5 | 0.5 | 0.962 | 1280 | 330 | 3380 | 0.5 | 6.1 × 10¹⁰ |
| Example | | | | | | | | | | | | | |
| 50 | | | | | | | | | | | | | |
| Working | Gd: 0.75 | — — | — — | 4.0 | 1.5 | 2.0 | 0.5 | 0.962 | 1220 | 320 | 3300 | 5.5 | 8.2 × 10⁹ |
| Example | | | | | | | | | | | | | |
| 51 | | | | | | | | | | | | | |
| Working | Gd: 0.75 | — — | — — | 4.0 | 1.5 | 5.0 | 0.5 | 0.962 | 1200 | 330 | 3320 | 7.8 | 7.0 × 10⁹ |
| Example | | | | | | | | | | | | | |
| 52 | | | | | | | | | | | | | |
| Working | Gd: 0.75 | — — | — — | 1.0 | 1.5 | 1.0 | 0.5 | 0.990 | 1230 | 430 | 3640 | 1.8 | 1.3 × 10¹¹ |
| Example | | | | | | | | | | | | | |
| 53 | | | | | | | | | | | | | |
| Working | Gd: 0.75 | — — | — — | 2.0 | 1.5 | 1.0 | 0.5 | 0.980 | 1240 | 360 | 3350 | 0.3 | 8.7 × 10¹⁰ |
| Example | | | | | | | | | | | | | |
| 54 | | | | | | | | | | | | | |
| Working | Gd: 0.75 | — — | — — | 6.0 | 1.5 | 1.0 | 0.5 | 0.943 | 1270 | 300 | 3050 | 1.0 | 3.8 × 10⁹ |
| Example | | | | | | | | | | | | | |
| 55 | | | | | | | | | | | | | |
| Working | Gd: 0.75 | — — | — — | 8.0 | 1.5 | 1.0 | 0.5 | 0.926 | 1270 | 350 | 2550 | 1.5 | 1.2 × 10⁹ |
| Example | | | | | | | | | | | | | |
| 56 | | | | | | | | | | | | | |

TABLE 4

| | Average | | | |
|---|---|---|---|---|
| | particle | | | Resistivity @150° C. |
| | diameter (nm) | ε | (Δε/° C.) | (Ω · cm) |
| Working | 280 | 3050 | 0.3 | 2.5 × 10⁸ |
| Example 6 | | | | |
| Working | 320 | 3300 | 0.4 | 3.0 × 10⁹ |
| Example 7 | | | | |
| Working | 330 | 3350 | 0.5 | 6.1 × 10⁹ |
| Example 8 | | | | |
| Working | 340 | 3350 | 0.5 | 6.3 × 10⁹ |
| Example 9 | | | | |
| Working | 370 | 3180 | 0.6 | 3 × 10¹⁰ |
| Example 10 | | | | |
| Working | 360 | 3150 | 0.6 | 4.7 × 10¹⁰ |
| Example 11 | | | | |
| Working | 250 | 2680 | 0.2 | 5.2 × 10¹⁰ |
| Example 12 | | | | |
| Working | 300 | 3230 | 0.4 | 4.1 × 10⁹ |
| Example 13 | | | | |
| Working | 330 | 3070 | 0.4 | 9.5 × 10⁸ |
| Example 14 | | | | |
| Working | 310 | 3200 | 0.3 | 5.5 × 10¹⁰ |
| Example 15 | | | | |
| Working | 420 | 3750 | 4.3 | 2.8 × 10¹¹ |
| Example 16 | | | | |
| Working | 400 | 3520 | 3.3 | 9.2 × 10¹⁰ |
| Example 17 | | | | |
| Working | 360 | 3320 | 2.3 | 1.8 × 10¹⁰ |
| Example 18 | | | | |
| Working | 250 | 2830 | 1.3 | 1.5 × 10¹⁰ |
| Example 19 | | | | |
| Working | 300 | 3270 | 1.0 | 6.1 × 10 |
| Example 20 | | | | |
| Working | 320 | 3300 | 0.8 | 8.1 × 10⁹ |
| Example 21 | | | | |
| Working | 320 | 3130 | 0.5 | 1.2 × 10¹⁰ |
| Example 22 | | | | |
| Working | 350 | 3030 | 1.3 | 2.4 × 10¹⁰ |
| Example 23 | | | | |
| Working | 350 | 2880 | 0.3 | 3.7 × 10¹⁰ |
| Example 24 | | | | |
| Working | 300 | 2620 | 1.0 | 3.8 × 10¹⁰ |
| Example 25 | | | | |
| Working | 270 | 3010 | 0.8 | 3.9 × 10¹⁰ |
| Example 26 | | | | |
| Working | 390 | 3410 | 0.5 | 1.1 × 10¹⁰ |
| Example 27 | | | | |
| Working | 410 | 3680 | 1.5 | 6.8 × 10⁹ |
| Example 28 | | | | |
| Working | 260 | 2950 | 0.2 | 1.0 × 10⁹ |
| Example 29 | | | | |
| Working | 330 | 3450 | 1.0 | 7.5 × 10⁸ |
| Example 30 | | | | |
| Working | 290 | 3100 | 0.2 | 6.0 × 10¹⁰ |
| Example 31 | | | | |
| Working | 420 | 3740 | 1.7 | 7.3 × 10¹⁰ |
| Example 32 | | | | |
| Working | 310 | 3200 | 0.3 | 8.3 × 10¹⁰ |
| Example 33 | | | | |
| Working | 440 | 3800 | 1.9 | 9.3 × 10¹⁰ |
| Example 34 | | | | |
| Working | 320 | 3230 | 0.3 | 8.9 × 10¹⁰ |
| Example 35 | | | | |
| Working | 450 | 3820 | 2.0 | 9.4 × 10¹⁰ |
| Example 36 | | | | |
| Working | 350 | 3110 | 0.5 | 9.5 × 10¹⁰ |
| Example 37 | | | | |
| Working | 470 | 3580 | 2.2 | 3.5 × 10¹¹ |
| Example 38 | | | | |
| Working | 340 | 3010 | 0.5 | 1.6 × 10¹¹ |
| Example 39 | | | | |
| Working | 450 | 3140 | 2.3 | 4.9 × 10¹¹ |
| Example 40 | | | | |
| Working | 270 | 2320 | 0.2 | 3.3 × 10¹¹ |
| Example 41 | | | | |
| Working | 230 | 2130 | 0.1 | 5.1 × 10¹¹ |
| Example 42 | | | | |
| Working | 290 | 3140 | 0.5 | 7.7 × 10¹⁰ |
| Example 43 | | | | |
| Working | 420 | 3540 | 1.6 | 1.5 × 10¹⁰ |
| Example 44 | | | | |
| Working | 330 | 3040 | 0.4 | 5.5 × 10⁹ |
| Example 45 | | | | |
| Working | 420 | 3300 | 0.7 | 4.9 × 10⁹ |
| Example 46 | | | | |
| Working | 300 | 3180 | 0.3 | 7.1 × 10¹⁰ |
| Example 47 | | | | |
| Working | 430 | 3760 | 1.2 | 5.7 × 10¹⁰ |
| Example 48 | | | | |
| Working | 340 | 3400 | 3.0 | 8.5 × 10¹⁰ |
| Example 49 | | | | |
| Working | 330 | 3380 | 0.5 | 6.1 × 10¹⁰ |
| Example 50 | | | | |
| Working | 320 | 3300 | 5.5 | 8.2 × 10⁹ |
| Example 51 | | | | |
| Working | 330 | 3320 | 7.8 | 7.0 × 10⁹ |
| Example 52 | | | | |
| Working | 430 | 3640 | 1.8 | 1.3 × 10¹¹ |
| Example 53 | | | | |
| Working | 360 | 3350 | 0.3 | 8.7 × 10¹⁰ |
| Example 54 | | | | |
| Working | 300 | 3050 | 1.0 | 3.8 × 10⁹ |
| Example 55 | | | | |
| Working | 350 | 2550 | 1.5 | 1.2 × 10⁹ |
| Example 56 | | | | |

Working Examples 53 to 56 are working examples of dielectric ceramic compositions in which the amount of TiO₂ added was changed to 1.0 mol, 2.0 mol, 6.0 mol, and 8.0 mol relative to 100 mol of BaTiO₃. Together with Working Example 22, these were examples for determining the upper and lower limits for the amount of TiO₂ in the range from 1.0 to 8.0 mol while fixing the amounts of the other additives, Gd₂O₃, MnCO₃, SiO₂ and MgO.

It was found that in Working Examples 53 to 56 and Working Example 22, the value of Δε/° C. was 2 or less, indicating that the dielectric constant was extremely stable with respect to the firing temperature. Furthermore, the average particle/grain diameter was also 500 nm or less, and the resistivity at 150° C. was also 2.0×10⁸ Ω·cm or more. Therefore, even in short-time firing due to rapid temperature rise, it is possible to achieve higher mass production and to obtain sufficient reliability. Note that in Working Example 56, the dielectric constant was 2550. In Working Examples 53 to 56 and Working Example 22, the relative permittivity tends to decrease as the added amount increases, so it was found that adding more than 8.0 mol of TiO₂ to 100 mol of BaTiO₃ is not advantageous because it was apparent that the dielectric constant would further decrease. Thus, it was determined that an additional amount greater than this is outside the scope of the present invention. Tables 3 and 4 summarize the amounts of additives added in Working Examples 6 to 56, as well as the firing temperature, average particle diameter, ε, Δε/° C., and resistivity at 150° C.

Furthermore, in order to evaluate or confirm whether the dielectric ceramic compositions of Working Examples 6 to 56 have the microstructural features described in the embodiments above, TEM-EDS, SEM-EDS and XRD measurements were performed to determine whether the core-shell structure exists, whether Ba₄Ti¹¹O₂₆ exists, whether the elemental ratio v of barium to titanium in the second crystal grain 42 is in the range of 0.16≤v≤0.70, and the elemental ratio w of manganese to titanium is in the range of 0.02≤w≤0.10. The results are summarized in Table 5.

TABLE 5

| | | | | | | | | | | | Secondary | |
|---|---|---|---|---|---|---|---|---|---|---|---|---|
| | | Shell | | | | Core | | | | | crystal grain | |
| | Core | | | | Mn/Ti | | | | Mn/Ti | Ba₄Ti₁₁ | Ba/Ti | Mn/Ti |
| | shell | Rare earth elements/Ti | | | Element | Rare earth elements/Ti | | | Element | O₂₆ | Element | Element |
| | exists? | Element ratio | | | ratio | Element ratio | | | ratio | found? | ratio | ratio |
| Working | Yes | Eu: 0.023 | — — | — — | 0.019 | Eu: 0.000 | — — | — — | 0.000 | Yes | 0.47 | 0.03 |
| Example | | | | | | | | | | | | |
| 6 | | | | | | | | | | | | |
| Working | Yes | Tb: 0.027 | — — | — — | 0.025 | Tb: 0.000 | — — | — — | 0.001 | Yes | 0.53 | 0.02 |
| Example | | | | | | | | | | | | |
| 7 | | | | | | | | | | | | |
| Working | Yes | Dy: 0.028 | — — | — — | 0.026 | Dy: 0.001 | — — | — — | 0.001 | Yes | 0.49 | 0.04 |
| Example | | | | | | | | | | | | |
| 8 | | | | | | | | | | | | |
| Working | Yes | Y: 0.028 | — — | — — | 0.025 | Y: 0.001 | — — | — — | 0.002 | Yes | 0.48 | 0.04 |
| Example | | | | | | | | | | | | |
| 9 | | | | | | | | | | | | |
| Working | Yes | Ho: 0.034 | — — | — — | 0.028 | Ho: 0.003 | — — | — — | 0.003 | Yes | 0.54 | 0.05 |
| Example | | | | | | | | | | | | |
| 10 | | | | | | | | | | | | |
| Working | Yes | Er: 0.029 | — — | — — | 0.026 | Er: 0.001 | — — | — — | 0.001 | Yes | 0.51 | 0.03 |
| Example | | | | | | | | | | | | |
| 11 | | | | | | | | | | | | |
| Working | Yes | Yb: 0.019 | — — | — — | 0.017 | Yb: 0.000 | — — | — — | 0.000 | Yes | 0.27 | 0.02 |
| Example | | | | | | | | | | | | |
| 12 | | | | | | | | | | | | |
| Working | Yes | Gd: 0.012 | Dy: 0.014 | — — | 0.023 | Gd: 0.000 | Dy: 0.000 | — — | 0.002 | Yes | 0.50 | 0.04 |
| Example | | | | | | | | | | | | |
| 13 | | | | | | | | | | | | |
| Working | Yes | Eu: 0.010 | Ho: 0.018 | — — | 0.024 | Eu: 0.000 | Ho: 0.000 | — — | 0.003 | Yes | 0.39 | 0.06 |
| Example | | | | | | | | | | | | |
| 14 | | | | | | | | | | | | |
| Working | Yes | Gd: 0.008 | Tb: 0.009 | Y: 0.009 | 0.022 | Gd: 0.000 | Tb: 0.000 | Y: 0.000 | 0.001 | Yes | 0.26 | 0.02 |
| Example | | | | | | | | | | | | |
| 15 | | | | | | | | | | | | |
| Working | Yes | Gd: 0.034 | — — | — — | 0.00 | Gd: 0.010 | — — | — — | 0.000 | Yes | 0.46 | 0.02 |
| Example | | | | | | | | | | | | |
| 16 | | | | | | | | | | | | |
| Working | Yes | Gd: 0.025 | — — | — — | 0.014 | Gd: 0.000 | — — | — — | 0.001 | Yes | 0.38 | 0.03 |
| Example | | | | | | | | | | | | |
| 17 | | | | | | | | | | | | |
| Working | Yes | Gd: 0.025 | — — | — — | 0.026 | Gd: 0.000 | — — | — — | 0.002 | Yes | 0.41 | 0.03 |
| Example | | | | | | | | | | | | |
| 18 | | | | | | | | | | | | |
| Working | Yes | Gd: 0.022 | — — | — — | 0.040 | Gd: 0.000 | — — | — — | 0.008 | Yes | 0.33 | 0.09 |
| Example | | | | | | | | | | | | |
| 19 | | | | | | | | | | | | |
| Working | Yes | Gd: 0.035 | — — | — — | 0.028 | Gd: 0.000 | — — | — — | 0.000 | Yes | 0.48 | 0.03 |
| Example | | | | | | | | | | | | |
| 20 | | | | | | | | | | | | |
| Working | Yes | Gd: 0.032 | — — | — — | 0.025 | Gd: 0.001 | — — | — — | 0.000 | Yes | 0.32 | 0.03 |
| Example | | | | | | | | | | | | |
| 21 | | | | | | | | | | | | |
| Working | Yes | Gd: 0.027 | — — | — — | 0.023 | Gd: 0.000 | — — | — — | 0.000 | Yes | 0.44 | 0.03 |
| Example | | | | | | | | | | | | |
| 22 | | | | | | | | | | | | |
| Working | Yes | Gd: 0.028 | — — | — — | 0.027 | Gd: 0.000 | — — | — — | 0.000 | Yes | 0.48 | 0.03 |
| Example | | | | | | | | | | | | |
| 23 | | | | | | | | | | | | |
| Working | Yes | Gd: 0.028 | — — | — — | 0.025 | Gd: 0.000 | — — | — — | 0.000 | Yes | 0.49 | 0.02 |
| Example | | | | | | | | | | | | |
| 24 | | | | | | | | | | | | |
| Working | Yes | Gd: 0.027 | — — | — — | 0.025 | Gd: 0.000 | — — | — — | 0.000 | Yes | 0.29 | 0.04 |
| Example | | | | | | | | | | | | |
| 25 | | | | | | | | | | | | |
| Working | Yes | Gd: 0.011 | — — | — — | 0.018 | Gd: 0.002 | — — | — — | 0.000 | Yes | 0.49 | 0.03 |
| Example | | | | | | | | | | | | |
| 26 | | | | | | | | | | | | |
| Working | Yes | Gd: 0.038 | — — | — — | 0.022 | Gd: 0.000 | — — | — — | 0.000 | Yes | 0.45 | 0.03 |
| Example | | | | | | | | | | | | |
| 27 | | | | | | | | | | | | |
| Working | Yes | Gd: 0.045 | — — | — — | 0.021 | Gd: 0.004 | — — | — — | 0.000 | Yes | 0.45 | 0.02 |
| Example | | | | | | | | | | | | |
| 28 | | | | | | | | | | | | |
| Working | Yes | Eu: 0.011 | — — | — — | 0.018 | Eu: 0.000 | — — | — — | 0.000 | Yes | 0.47 | 0.03 |
| Example | | | | | | | | | | | | |
| 29 | | | | | | | | | | | | |
| Working | Yes | Eu: 0.041 | — — | — — | 0.019 | Eu: 0.002 | — — | — — | 0.001 | Yes | 0.46 | 0.02 |
| Example | | | | | | | | | | | | |
| 30 | | | | | | | | | | | | |
| Working | Yes | Tb: 0.016 | — — | — — | 0.021 | Tb: 0.000 | — — | — — | 0.000 | Yes | 0.53 | 0.02 |
| Example | | | | | | | | | | | | |
| 31 | | | | | | | | | | | | |
| Working | Yes | Tb: 0.050 | — — | — — | 0.027 | Tb: 0.003 | — — | — — | 0.001 | Yes | 0.52 | 0.01 |
| Example | | | | | | | | | | | | |
| 32 | | | | | | | | | | | | |
| Working | Yes | Dy: 0.015 | — — | — — | 0.026 | Dy: 0.000 | — — | — — | 0.001 | Yes | 0.53 | 0.04 |
| Example | | | | | | | | | | | | |
| 33 | | | | | | | | | | | | |
| Working | Yes | Dy: 0.052 | — — | — — | 0.027 | Dy: 0.004 | — — | — — | 0.003 | Yes | 0.55 | 0.04 |
| Example | | | | | | | | | | | | |
| 34 | | | | | | | | | | | | |
| Working | Yes | Y: 0.016 | — — | — — | 0.023 | Y: 0.000 | — — | — — | 0.001 | Yes | 0.51 | 0.04 |
| Example | | | | | | | | | | | | |
| 35 | | | | | | | | | | | | |
| Working | Yes | Y: 0.053 | — — | — — | 0.026 | Y: 0.004 | — — | — — | 0.003 | Yes | 0.48 | 0.04 |
| Example | | | | | | | | | | | | |
| 36 | | | | | | | | | | | | |
| Working | Yes | Ho: 0.020 | — — | — — | 0.028 | Ho: 0.000 | — — | — — | 0.003 | Yes | 0.52 | 0.02 |
| Example | | | | | | | | | | | | |
| 37 | | | | | | | | | | | | |
| Working | Yes | Ho: 0.066 | — — | — — | 0.032 | Ho: 0.007 | — — | — — | 0.005 | Yes | 0.55 | 0.03 |
| Example | | | | | | | | | | | | |
| 38 | | | | | | | | | | | | |
| Working | Yes | Er: 0.019 | — — | — — | 0.024 | Er: 0.000 | — — | — — | 0.000 | Yes | 0.50 | 0.03 |
| Example | | | | | | | | | | | | |
| 39 | | | | | | | | | | | | |
| Working | Yes | Er: 0.054 | — — | — — | 0.025 | Er: 0.002 | — — | — — | 0.002 | Yes | 0.49 | 0.03 |
| Example | | | | | | | | | | | | |
| 40 | | | | | | | | | | | | |
| Working | Yes | Yb: 0.022 | — — | — — | 0.018 | Yb: 0.000 | — — | — — | 0.000 | Yes | 0.33 | 0.04 |
| Example | | | | | | | | | | | | |
| 41 | | | | | | | | | | | | |
| Working | Yes | Yb: 0.090 | — — | — — | 0.015 | Yb: 0.000 | — — | — — | 0.000 | Yes | 0.27 | 0.02 |
| Example | | | | | | | | | | | | |
| 42 | | | | | | | | | | | | |
| Working | Yes | Gd: 0.007 | Dy: 0.008 | — — | 0.020 | Gd: 0.000 | Dy: 0.000 | — 0.000 | 0.000 | Yes | 0.49 | 0.03 |
| Example | | | | | | | | | | | | |
| 43 | | | | | | | | | | | | |
| Working | Yes | Gd: 0.024 | Dy: 0.027 | — — | 0.023 | Gd: 0.004 | Dy: 0.000 | — 0.000 | 0.003 | Yes | 0.52 | 0.03 |
| Example | | | | | | | | | | | | |
| 44 | | | | | | | | | | | | |
| Working | Yes | Eu: 0.004 | Ho: 0.012 | — — | 0.019 | Eu: 0.000 | Ho: 0.000 | — 0.000 | 0.001 | Yes | 0.38 | 0.03 |
| Example | | | | | | | | | | | | |
| 45 | | | | | | | | | | | | |
| Working | Yes | Eu: 0.026 | Ho: 0.036 | — — | 0.022 | Eu: 0.002 | Ho: 0.003 | — 0.000 | 0.003 | Yes | 0.35 | 0.04 |
| Example | | | | | | | | | | | | |
| 46 | | | | | | | | | | | | |
| Working | Yes | Gd: 0.003 | Tb: 0.004 | Y: 0.005 | 0.016 | Gd: 0.000 | Tb: 0.000 | Y: 0.000 | 0.000 | Yes | 0.34 | 0.04 |
| Example | | | | | | | | | | | | |
| 47 | | | | | | | | | | | | |
| Working | Yes | Gd: 0.022 | Tb: 0.027 | Y: 0.028 | 0.020 | Gd: 0.000 | Tb: 0.001 | Y: 0.002 | 0.001 | Yes | 0.30 | 0.02 |
| Example | | | | | | | | | | | | |
| 48 | | | | | | | | | | | | |
| Working | Yes | Gd: 0.035 | — — | — — | 0.028 | Gd: 0.012 | — — | — — | 0.000 | Yes | 0.27 | 0.05 |
| Example | | | | | | | | | | | | |
| 49 | | | | | | | | | | | | |
| Working | Yes | Gd: 0.034 | — — | — — | 0.028 | Gd: 0.003 | — — | — — | 0.000 | Yes | 0.46 | 0.05 |
| Example | | | | | | | | | | | | |
| 50 | | | | | | | | | | | | |
| Working | Yes | Gd: 0.031 | — — | — — | 0.019 | Gd: 0.000 | — — | — — | 0.000 | Yes | 0.55 | 0.03 |
| Example | | | | | | | | | | | | |
| 51 | | | | | | | | | | | | |
| Working | Yes | Gd: 0.023 | — — | — — | 0.020 | Gd: 0.000 | — — | — — | 0.000 | Yes | 0.56 | 0.03 |
| Example | | | | | | | | | | | | |
| 52 | | | | | | | | | | | | |
| Working | Yes | Gd: 0.026 | — — | — — | 0.023 | Gd: 0.000 | — — | — — | 0.001 | Yes | 0.61 | 0.04 |
| Example | | | | | | | | | | | | |
| 53 | | | | | | | | | | | | |
| Working | Yes | Gd: 0.025 | — — | — — | 0.031 | Gd: 0.000 | — — | — — | 0.002 | Yes | 0.49 | 0.05 |
| Example | | | | | | | | | | | | |
| 54 | | | | | | | | | | | | |
| Working | Yes | Gd: 0.025 | — — | — — | 0.028 | Gd: 0.001 | — — | — — | 0.000 | Yes | 0.44 | 0.05 |
| Example | | | | | | | | | | | | |
| 55 | | | | | | | | | | | | |
| Working | Yes | Gd: 0.030 | — — | — — | 0.027 | Gd: 0.002 | — — | — — | 0.002 | Yes | 0.42 | 0.03 |
| Example | | | | | | | | | | | | |
| 56 | | | | | | | | | | | | |

In Working Examples 6 to 56 in Table 5, it was determined that a core-shell structure existed, Ba₄Ti₁₁O₂₆ was found in XRD, and the elemental ratio v of barium to titanium and the elemental ratio w of manganese to titanium in the second crystal grains 42 were in the ranges of 0.16≤v≤0.70 and 0.02≤w≤0.10 so the presence of the second crystal grains 42 was also evident. In Working Examples 6 to 56, as shown in Table 4, the value of Δε/° C. was 12 or less, the resistivity at 150° C. was 2.0×10⁸ Ω·cm or more, the average particle/grain diameter was 500 nm or less, and the dielectric constant satisfied ε>2500 or more. Therefore, it was judged that they are suitable for use in a multilayer ceramic capacitor.

Although the embodiments of the present invention have been described in detail above, the present invention is not limited to the specific embodiments, and various modifications and changes are possible within the scope of the gist of the present invention described in the claims.

### DESCRIPTION OF REFERENCE CHARACTERS

10 Base
11 Dielectric layer
12 Internal electrode layer
13 Cover layer
14 Capacitance region
15 End margin
16 Side margin
20a, 20b External electrode
41 First crystal grain
42 Second crystal grain
43 Third crystal grain
44 Void
51 Ceramic green sheet
52 Internal electrode pattern
53 Dielectric pattern
54 Cover sheet
55 Side margin
100 Multilayer ceramic capacitor

What is claimed is:

1. A dielectric ceramic composition, comprising:
first crystal grains having a perovskite structure represented by a general formula ABO₃, each first crystal grain having a core portion and a shell portion, the shell portion covering the core portion and containing a rare earth element and manganese; and
second crystal grains whose main component is a barium titanate complex oxide in which an elemental ratio of barium to titanium is 0.70 or less.

2. The dielectric ceramic composition according to claim 1, wherein the rare earth element is at least one selected from gadolinium, europium, terbium, dysprosium, holmium, erbium, and ytterbium.

3. The dielectric ceramic composition according to claim 2, wherein the elemental ratio of barium to titanium is 0.926 or more and 0.995 or less, an elemental ratio of the rare earth element to titanium is 0.005 or more and 0.05 or less, and an elemental ratio of manganese to titanium is 0.002 or more and 0.05 or less.

4. The dielectric ceramic composition according to claim 1, further comprising silicon having an elemental ratio of 0.002 or more and 0.05 or less with respect to titanium and magnesium having an elemental ratio of 0.00 or more and 0.05 or less with respect to titanium.

5. The dielectric ceramic composition according to claim 1, wherein element concentrations of the rare earth element and manganese in the shell portion are higher than element concentrations of the rare earth element and manganese in the core portion.

6. The dielectric ceramic composition according to claim 1, wherein the first crystal grains have a maximum grain size of 2 μm or less.

7. The dielectric ceramic composition according to claim 1, wherein the second crystal grain has an elemental ratio of barium to titanium of 0.16 or more.

8. The dielectric ceramic composition according to claim 1, wherein the second crystal grain is at least one selected from BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

9. The dielectric ceramic composition according to claim 1, wherein the second crystal grain contains manganese, and an elemental ratio of manganese to titanium in the second crystal grain is 0.02 or more and 0.10 or less.

10. The dielectric ceramic composition according to claim 1, wherein the second crystal grain contains manganese, and an elemental ratio of manganese to titanium in the second crystal grain is 0.02 or more and 0.05 or less.

11. A dielectric ceramic composition, comprising:
first crystal grains having a perovskite structure represented by a general formula ABO₃, each first crystal grain having a core portion and a shell portion, the shell portion covering the core portion and containing a rare earth element and manganese; and
second crystal grains comprising a barium titanate complex oxide represented by Ba₄Ti₁₁O₂₆, and containing manganese with an elemental ratio of barium to titanium being 0.02 or more and 0.10 or less.

12. The dielectric ceramic composition according to claim 11, wherein the rare earth element is at least one selected from gadolinium, europium, terbium, dysprosium, holmium, erbium, and ytterbium.

13. The dielectric ceramic composition according to claim 12, wherein, the elemental ratio of barium to titanium is 0.926 or more and 0.995 or less, an elemental ratio of the rare earth element to titanium is 0.005 or more and 0.05 or less, and an elemental ratio of manganese to titanium is 0.002 or more and 0.05 or less.

14. The dielectric ceramic composition according to claim 11, further comprising silicon having an elemental ratio of 0.002 or more and 0.05 or less with respect to titanium and magnesium having an elemental ratio of 0.00 or more and 0.05 or less with respect to titanium.

15. The dielectric ceramic composition according to claim 11, wherein element concentrations of the rare earth element and manganese in the shell portion are higher than element concentrations of the rare earth element and manganese in the core portion.

16. The dielectric ceramic composition according to claim 1, wherein the first crystal grains have a maximum grain size of 2 μm or less.

17. The dielectric ceramic composition according to claim 11, wherein the elemental ratio of manganese to titanium in the second crystal grains is 0.02 or more and 0.05 or less.

18. A multilayer ceramic electronic component including the dielectric ceramic composition as set forth in claim 1.

19. A multilayer ceramic electronic component, comprising:
a plurality of internal electrodes facing each other;
dielectric layers provided between the plurality of internal electrodes and containing the dielectric ceramic composition as set forth in claim 1; and
external electrodes electrically connected to the internal electrodes, respectively.
